(19) United States
(12) Patent Application Publication
(10) Pub. No.: US 2023/0261481 A1
(43) Pub. Date: Aug. 17, 2023

(54) CELL BALANCING

(71) Applicant: Cirrus Logic International Semiconductor Ltd., Edinburgh (GB)

(72) Inventors: John P. LESSO, Edinburgh (GB); Robert A. STEVEN, Edinburgh (GB)

(73) Assignee: Cirrus Logic International Semiconductor Ltd., Edinburgh (GB)

(21) Appl. No.: 18/101,316

(22) Filed: Jan. 25, 2023

Related U.S. Application Data
(60) Provisional application No. 63/310,206, filed on Feb. 15, 2022.

(30) Foreign Application Priority Data
Feb. 25, 2022 (GB) 2202598.5

(51) Int. Cl. H02J 7/00; H02J 7/34

(52) U.S. Cl. CPC H02J 7/0019; H02J 7/345; H02J 7/0048

(57) ABSTRACT

A cell balancing system for balancing a set of series-connected cells, the cell balancing system comprising first balancer circuitry and second balancer circuitry. The first balancer circuitry comprises a first set of capacitors and a first switch network. The first switch network is controllable such that in operation of the cell balancing system: during a first phase of operation of the first balancer circuitry, a capacitor of the first set of capacitors is coupled to a first cell of the set of series-connected cells; and during a second phase of operation of the first balancer circuitry, the capacitor of the first set of capacitors is coupled to a second cell of the set of series-connected cells. The second balancer circuitry comprises a second set of capacitors and a second switch network. The second switch network is controllable such that in operation of the cell balancing system: during a first phase of operation of the second balancer circuitry, a capacitor of the second set of capacitors is coupled to a first subset of cells of the set of series-connected cells, the first subset comprising two or more of the set of series-connected cells; and during a second phase of operation of the second balancer circuitry, the capacitor of the second set of capacitors is coupled to a second subset of cells of the set of series-connected cells, different than the first subset, the second subset comprising two or more of the set of series-connected cells.

### FIELD OF THE INVENTION

The present disclosure relates to cell balancing circuitry for balancing a state of charge and/or voltage of cells of a set of cells, e.g. in a battery, battery module or battery pack.

### BACKGROUND

Battery packs are used in a wide variety of applications to provide electrical power. For example, portable devices (e.g. laptop computers, cordless power tools and the like) and larger devices such as electric scooters and bicycles may include a rechargeable battery pack to power the device. One of the largest areas of growth in demand for battery packs is electric vehicles (EVs), such as electric cars, vans, motorcycles and goods vehicles.

A battery pack is typically made up of a number of connected modules, each containing a plurality of individual cells that are connected together in series, parallel or series/parallel combinations in order to achieve a desired nominal output voltage and battery capacity.

FIG. 1a is a simplified schematic representation of an example battery pack. As shown, the battery pack 100a in this example comprises four modules 110-140 connected in parallel between positive and negative output terminals 150, 160. Each module 110-140 in this example comprises four individual cells (e.g. 112-118) connected in series.

By way of example, if each individual cell has a nominal capacity of 550 mAh (i.e. drawing a current of 550 mA from a fully charged cell for one hour would completely discharge the cell) and a nominal voltage of 1.2 v, the nominal output voltage of each module 110-140 in the FIG. 1a example will be 4.8 v, and the nominal capacity of each module 110-140 will be 550 mAh.

Because the modules 110-140 are connected in parallel, the nominal output voltage of the battery pack 100a is the same as the nominal output voltage of each module 110-140, i.e. 4.8 v, and the capacity of the battery pack 100a is equal to the sum of the capacity of each of the modules 110-140, i.e. 4×550 mAh=2200 mAh. Thus, connecting the cells in series permits a desired nominal output voltage (4.8 v in this example) to be achieved, whilst connecting the modules in parallel permits a desired nominal capacity (2200 mAh in this example) to be achieved.

As will be appreciated by those of ordinary skill in the art, many different permutations of series/parallel connections between cells and/or modules can be employed to achieve a desired nominal output voltage and capacity for a battery pack.

FIG. 1b is a simplified schematic representation of another example battery pack. As shown, the battery pack 100b in this example comprises two modules 170, 180 connected in parallel between positive and negative output terminals 150, 160. Each module 170, 180 in this example comprises four pairs 118a, 118b-124a, 124b of parallel-connected cells, which are coupled in series.

By way of example, if each individual cell has a nominal capacity of 550 mAh and a nominal voltage of 1.2 v, the nominal output voltage of a pair 118a, 118b-124a, 124b of cells is 1.2 v, and the nominal capacity of each pair 118a, 118b-124a, 124b of cells is 1100 mAh. The nominal voltage of each module 170, 180 in the FIG. 1b example will be 4.8 v, and the nominal capacity of each module 170, 180 will be 1100 mAh.

Because the modules 170, 180 are connected in parallel, the nominal output voltage of the battery pack 100b is the same as the nominal output voltage of each module 170, 180, i.e. 4.8 v, and the capacity of the battery pack 100b is equal to the sum of the capacity of each of the modules 170, 180, i.e. 2×1100 mAh=2200 mAh. Thus, the example battery pack 110b illustrated in FIG. 1b is an alternative configuration of a battery pack that provides the same nominal voltage and capacity as the example battery pack 110a shown in FIG. 1a.

As will be appreciated by those of ordinary skill in the art, many applications will require a battery pack with a greater nominal output voltage and/or a greater nominal capacity than those of the example battery packs 110a, 110b shown in FIGS. 1a and 1 b. For example, a battery pack for an electric vehicle may use two parallel-connected strings of cells, each string containing 96 series-connected cells each having a nominal voltage of 3.7-4 v and a nominal capacity of 55 Ah. The nominal output voltage of such a battery pack is of the order of 400 v, and the nominal capacity is of the order of 110 Ah.

FIGS. 2a-2e show some examples of different series/parallel connections between cells that could be used in a module or a battery pack. FIG. 2a shows a single cell. FIG. 2b shows a single string 220 comprising two cells connected in series, in a configuration that may be denoted 2s1p. FIG. 2c shows two cells connected in parallel, in a configuration that may be denoted 1s2p. FIG. 2d shows two parallel-connected strings 240a, 240b, each containing three series-connected cells, in a configuration that may be denoted 3s2p. FIG. 2e shows three parallel-connected strings 250a-250c, each containing two series-connected cells, in a configuration that may be denoted 2s3p. More generally, the notation XsYp indicates Y parallel-connected strings, each containing X series-connected cells. Thus, the battery pack 100a illustrated in FIG. 1a may be denoted 4s4p (or B4s4p, where B indicates that the arrangement is a battery pack), since it contains four parallel-connected strings each containing four series-connected cells. More generally, a battery pack comprising Y parallel strings each containing X series-connected cells may be denoted BXsYp, while a module comprising Y parallel strings each containing X series-connected cells may be denoted MXsYp.

In use of a battery pack of the kind described above with reference to FIG. 1, it is important that discharging stops when any one of the individual cells reaches a defined lower limit, i.e. a lower threshold, of voltage or charge. Continued use of the battery pack beyond this point risks permanently damaging the particular cell that has reached the lower limit of charge through excessive discharge of that cell, making it impossible subsequently to recharge the cell effectively. Similarly, when the battery pack is being charged, charging must stop when the voltage across any one of the individual cells reaches a defined upper limit, i.e. an upper threshold. Continued charging after this upper limit has been reached risks permanently damaging the particular cell that has reached the upper limit, or more severe consequences such as thermal runaway for example.

Although the nominal capacity of all of the cells in a battery pack may be the same, inevitable variations in capacity between cells (resulting from, for example, manufacturing tolerances, cell aging, variations in the temperature to which the individual cells are exposed and the like) will result in variations in capacity between cells, resulting in non-uniform charging and discharging characteristics between the cells of the battery pack, such that some cells will reach the lower limit of voltage or charge during use, and/or the upper voltage limit during charging, more quickly than others. As will be appreciated, however, constraining use of the battery pack based on a discharge characteristic, such as the discharge rate, of a particular cell with the lowest capacity will lead to an unnecessary reduction in the usable energy of the battery pack between charges, since the other cells will still have capacity when the particular cell has reached the lower limit of voltage or charge. Similarly, constraining charging of the battery pack based on a charging characteristic, such as the charging rate, of a particular cell which reaches the upper voltage limit first will result in an unnecessary reduction in the usable energy of the battery pack between charges, because charging of the battery pack will stop before all of the cells are fully charged.

To mitigate these issues, cell balancing strategies may be used. The aim of cell balancing is to equalise (to the maximum extent possible) the state of charge/discharge and/or the voltage of each cell in the battery pack.

FIG. 3 illustrates the concept of passive cell balancing, which is typically used during charging of a battery pack. FIG. 3 shows a battery pack 300 having four cells 312-318. The hatched areas of the cells 312-318 represent the state of charge (SoC) of the cells. As can be seen, the second and third cells 314, 316 are at a first SoC (SoC1), the first cell 312 is at a second SoC (SoC2), which is higher than SoC1, and the fourth cell 318 is at a third SoC (SoC3), which is lower than SoC1.

A cell balancing module 320 is used during charging of the battery pack 300 to equalise the state of charge and/or voltage of the cells 312-318 by diverting charging current away from any cell whose voltage or state of charge reaches a threshold level (which may be, for example, the upper voltage limit of the cell) while the voltage or state of charge of one or more of the other cells is below the threshold. The cell balancing module 320 includes a plurality of switches 322-328, by means of which each cell 312-318 can be coupled to a respective shunt resistor 332-338 to divert charging current away from any cell that has reached the threshold level.

In the example illustrated in FIG. 3, the threshold level is set at SoC2. As the first cell 312 is already at SoC2, the cell balancing module 320 is operative to divert charging current from the first cell, by closing a first switch 322 to couple the first cell 312 to a first shunt resistor 332. Thus, energy is dissipated as heat in the first shunt resistor 332 instead of charging the first cell 312.

The second, third and fourth cells 314-318 are below the threshold, so charging current is not diverted from them. Thus, second, third and fourth switches 324-328 remain open such that charging current is not diverted away from the cells 314-318. However, if one of the cells 314-318 reaches the threshold level before the others, the associated switch will be closed to couple that cell to the relevant shunt resistor. For example, if the second cell 314 reaches the threshold level before the third and fourth cells 316, 318, the second switch 324 will be closed to divert charging current that would otherwise reach the second cell 314 to the second shunt resistor 334.

Passive cell balancing can also be used during operation of a host device that is powered by the battery pack 300, by coupling a cell with a higher SoC and/or voltage to a shunt resistor to convert stored electrical energy into heat, thereby reducing the SoC and/or voltage of that cell (i.e. discharging the cell) until it is equal to the SoC and/or voltage of another cell of the battery pack 300, e.g. the cell with the lowest SoC and/or voltage. (Note that for many cell chemistries an open-circuit voltage (OCV) of the cell increases monotonically with the cell's state of charge, so in this context terms voltage and state of charge can be used interchangeably).

However, passive cell balancing reduces the usable energy of the battery pack between charges, since stored electrical energy that is converted to heat cannot be used to operate the host device. In the context of electric vehicles, this is manifested as a reduction in the range of the vehicle, which is undesirable.

As will be apparent to those of ordinary skill in the art, passive cell balancing in this way is inefficient, because energy is wasted as heat when the charging current is diverted to the shunt resistors. Passive cell balancing can only reduce the state of charge or voltage of a strong cell; it cannot increase the state of charge or voltage of a weak cell.

FIG. 4 illustrates the concept of active cell balancing. FIG. 4 shows a battery pack 400 having four cells 412-418. The patterned areas of the cells 412-418 represent the state of charge (SoC) of the cells. As can be seen, the second and third cells 414, 416 are at a first SoC (SoC1), the first cell 412 is at a second SoC (SoC2), which is higher than SoC1 (the dotted portion of the first cell 412 represents the difference between SoC1 and SoC2), and the fourth cell 418 is at a third SoC (SoC3), which is lower than SoC1.

A cell balancing module 420 is coupled to the battery pack 400 and is operative to transfer energy between the cells 412-418 so as to transfer the “excess” energy from the first cell 412 to the fourth cell 418, to balance or equalise (to the extent possible), the state of charge and/or voltage of the cells 412-418. The cell balancing module may be based on a switched capacitor or switched inductor architecture, for example.

As will be appreciated, active cell balancing provides a more efficient way of balancing or equalising the SoC and/or voltage of cells in a battery pack, but requires more complex cell balancing circuitry. Because energy is not wasted as heat during active cell balancing, but is instead transferred between cells, a battery pack that is subject to active cell balancing will require recharging less frequently than an equivalent battery pack that is subject to passive cell balancing (assuming that there is a mismatch in the battery pack that requires balancing), and thus active cell balancing may reduce the environmental impact of a battery pack over its useable lifetime, in comparison to an equivalent battery pack that is subject to passive cell balancing.

### SUMMARY

According to a first aspect, the invention provides a cell balancing system for balancing a set of series-connected cells, the cell balancing system comprising:
first balancer circuitry comprising a first set of capacitors and a first switch network, wherein the first switch network is controllable such that in operation of the cell balancing system:
   during a first phase of operation of the first balancer circuitry, a capacitor of the first set of capacitors is coupled to a first cell of the set of series-connected cells; and
   during a second phase of operation of the first balancer circuitry, the capacitor of the first set of capacitors is coupled to a second cell of the set of series-connected cells; and
second balancer circuitry comprising a second set of capacitors and a second switch network, wherein the second switch network is controllable such that in operation of the cell balancing system:
   during a first phase of operation of the second balancer circuitry, a capacitor of the second set of capacitors is coupled to a first subset of cells of the set of series-connected cells, the first subset comprising two or more of the set of series-connected cells; and
   during a second phase of operation of the second balancer circuitry, the capacitor of the second set of capacitors is coupled to a second subset of cells of the set of series-connected cells, different than the first subset, the second subset comprising two or more of the set of series-connected cells.

The second switch network may be operable to couple the capacitor of the second set of capacitors in parallel with the first subset of cells during the first phase of operation of the second balancer circuitry, and to couple the capacitor in parallel with the second subset of cells during the second phase of operation of the second balancer circuitry.

The second set of capacitors may comprise N−1 capacitors, where N is the number of cells in the set of series connected cells.

The second switch network may comprise 2(N−1)² switches, where N is the number of cells in the set of series connected cells.

Each capacitor of the second set of capacitors may be associated with 2(N−1) switches of the second switch network.

An operational cycle of the second balancer circuitry may comprise N−1 phases. Over the course of an operational cycle of the second balancer circuitry, each capacitor of the second set of capacitors may be coupled once to each of N−1 subsets of the set of series-connected cells, each subset comprising two or more cells.

The second set of capacitors may comprise a plurality of capacitors coupled in parallel between the second switch network and a common node.

The second set of capacitors may comprise N−1 capacitors, where N is the number of cells in the set of series connected cells.

The second switch network may comprise 2(N−1) switches.

The second set of capacitors may comprise N/2 capacitors, where N is the number of cells in the set of series-connected cells, and where N is an integer multiple of 2.

The second switch network may comprise 2(N/2) switches.

The first switch network may be operable to couple the capacitor of the first set of capacitors in parallel with the first cell during the first phase of operation of the first balancer circuitry, and to couple the capacitor in parallel with the second cell during the second phase of operation of the second balancer circuitry.

The first set of capacitors may comprise N−1 capacitors, where N is the number of cells in the set of series-connected cells.

The first set of capacitors may comprise a plurality of capacitors coupled in parallel between the first switch network and a common node.

The first set of capacitors may comprise N capacitors, where N is the number of cells of the set of series-connected cells.

The first switch network may comprise 2N switches, where N is the number of cells of the set of series-connected cells.

Each capacitor of the first set of capacitors may be associated with two switches of the first switch network.

The cell balancing system may further comprise control circuitry configured to control operation of the first switch network and the second switch network.

The first balancer circuitry and the second balancer circuitry may be configured to receive a common clock signal.

The first balancer circuitry may be configured to receive a first clock signal and the second balancer circuitry may be configured to receive a second clock signal.

The first set of capacitors may comprise a first plurality of capacitors coupled in parallel between the first switch network and a first common node and the second set of capacitors may comprise a second plurality of capacitors coupled in parallel between the second switch network and a second common node.

The cell balancing system may comprise common voltage monitor circuitry for coupling to the first and second common nodes.

The first common node may be coupled to the second common node.

The cell balancing system may comprise first voltage monitor circuitry for coupling to the first common node and second voltage monitor circuitry for coupling to the second common node.

The first balancer circuitry and the second balancer circuitry may be operable simultaneously or concurrently.

The first balancer circuitry and the second balancer circuitry may be operable separately of one another.

The first balancer may be operable continuously, and the second balancer may be inoperative or operative at a low frequency unless a predetermined condition is met.

The predetermined condition may comprise a threshold level of mismatch between a voltage or a state of charge between cells of the set of series-connected cells.

The second balancer may be operable for a first period until a predefined condition is met, and the first balancer circuitry may be operable thereafter.

According to a second aspect, the invention provides an integrated circuit comprising a cell balancing system according to any of the preceding claims.

According to a third aspect, the invention provides a host device comprising a cell balancing system according to the first aspect.

The host device may comprise an electric vehicle, an electric bicycle, a wheelchair, an electric scooter, a cordless power tool, a computing device, a laptop, notebook or tablet computer, a portable battery powered device, a mobile telephone or an accessory device for such a host device.

According to a fourth aspect, the invention provides an battery pack comprising a cell balancing system according to the first aspect.

According to a fifth aspect, the invention provides an integrated circuit comprising a first switch network and/or a second switch network for a cell balancing system according to the first aspect.

The integrated circuit may further comprise control circuitry for controlling the first and/or second switch networks.

According to a sixth aspect, the invention provides a module comprising an integrated circuit according to the fifth aspect and first and/or second sets of capacitors.

According to a seventh aspect, the invention provides a cell balancing system for balancing a set of series-connected cells, the cell balancing system comprising:
first balancer circuitry comprising a first set of capacitors and a first switch network, wherein the first set of capacitors comprises a plurality of capacitors coupled in parallel between the first switch network and a common node, and wherein the first switch network is controllable such that in operation of the cell balancing system:
   during a first phase of operation of the first balancer circuitry, a capacitor of the first set of capacitors is coupled to a first cell of the set of series-connected cells; and
   during a second phase of operation of the first balancer circuitry, the capacitor of the first set of capacitors is coupled to a second cell of the set of series-connected cells; and
second balancer circuitry comprising a second set of capacitors and a second switch network, wherein the second switch network is controllable such that in operation of the cell balancing system:
   during a first phase of operation of the second balancer circuitry, a capacitor of the second set of capacitors is coupled to a first subset of cells of the set of series-connected cells, the first subset comprising two or more of the set of series-connected cells; and
   during a second phase of operation of the second balancer circuitry, the capacitor of the second set of capacitors is coupled to a second subset of cells of the set of series-connected cells, different than the first subset, the second subset comprising two or more of the set of series-connected cells.

According to an eighth second aspect, the invention provides a cell balancing system for balancing a set of series-connected cells, the cell balancing system comprising:
first balancer circuitry comprising a first set of capacitors and a first switch network, wherein the first switch network is controllable such that in operation of the cell balancing system:
   during a first phase of operation of the first balancer circuitry, a capacitor of the first set of capacitors is coupled to a first cell of the set of series-connected cells; and
   during a second phase of operation of the first balancer circuitry, the capacitor of the first set of capacitors is coupled to a second cell of the set of series-connected cells; and
second balancer circuitry comprising a second set of capacitors and a second switch network, wherein the second set of capacitors comprises N−1 capacitors, where N is the number of cells in the set of series connected cells, and wherein the second switch network is controllable such that in operation of the cell balancing system:
   during a first phase of operation of the second balancer circuitry, a capacitor of the second set of capacitors is coupled to a first subset of cells of the set of series-connected cells, the first subset comprising two or more of the set of series-connected cells; and
   during a second phase of operation of the second balancer circuitry, the capacitor of the second set of capacitors is coupled to a second subset of cells of the set of series-connected cells, different than the first subset, the second subset comprising two or more of the set of series-connected cells.

### BRIEF DESCRIPTION OF THE DRAWINGS

Embodiments of the invention will now be described, strictly by way of example only, with reference to the accompanying drawings, of which:

FIG. 1a is a simplified schematic representation of an example battery pack;

FIG. 1b is a simplified schematic representation of an alternative example battery pack;

FIGS. 2a-2e show examples of different series/parallel connections between cells that could be used in a battery pack or a module of a battery pack;

FIG. 3 illustrates the concept of passive cell balancing;

FIG. 4 illustrates the concept of active cell balancing;

FIG. 5 is a schematic representation of active cell balancing circuitry;

FIG. 6 is a schematic representation of a cell balancing system according to the present disclosure;

FIGS. 7a-7d schematically illustrate the structure and operation of an implementation of second balancer circuitry for use in the cell balancing system of FIG. 6;

FIGS. 8a-8c schematically illustrate the structure and operation of an alternative implementation of second balancer circuitry for use in the cell balancing system of FIG. 6;

FIGS. 9a-9c schematically illustrate the structure and operation of a further alternative implementation of second balancer circuitry for use in the cell balancing system of FIG. 6; and

FIGS. 10a-10c schematically illustrate the structure and operation of an implementation of first balancer circuitry for use in the cell balancing system of FIG. 6.

### DETAILED DESCRIPTION

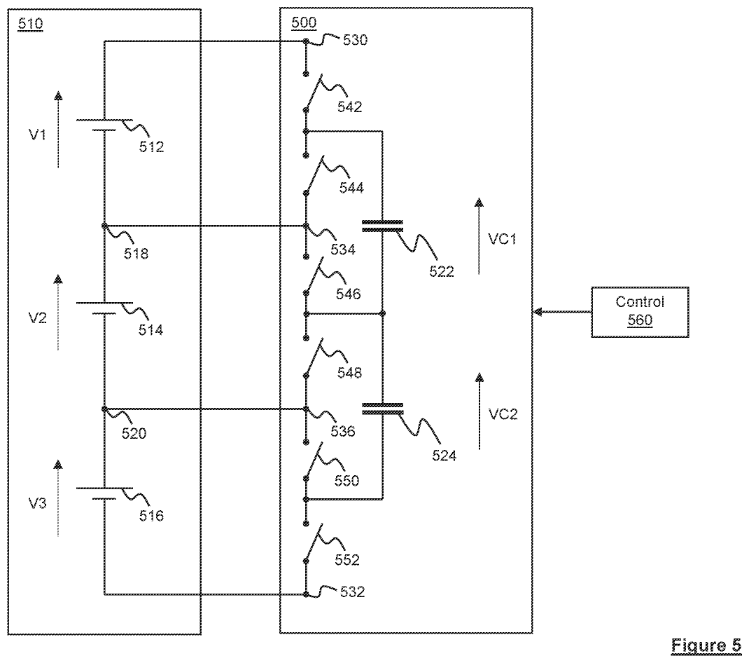

FIG. 5 is a schematic representation of cell balancing circuitry. In this example the cell balancing circuitry (shown generally at 500) is based on a switched series-connected capacitor architecture, and is operable to balance or equalise, at least partially, a state of charge (SoC) and/or voltage between a plurality (in this example first to third) of series-connected cells 512, 514, 516 in a battery pack 510.

The cell balancing circuitry 500 comprises first and second series-connected capacitors 522, 524, a switch network comprising first to sixth switches 542-552, and control circuitry 560 to control the operation of the switches 542-552.

More generally, for a battery pack 510 comprising N cells, the cell balancing circuitry 500 will comprise N−1 capacitors and a switch network comprising 2N switches. In the particular example shown in FIG. 5, N=3.

The first to sixth switches 542-552 are coupled in series between first and second switch network nodes 530, 532. A first terminal of the first capacitor 522 is coupled to a node between the first and second switches 542, 544. A second terminal of the first capacitor 522 is coupled to a node between the third and fourth switches 546, 548 and to a first terminal of the second capacitor 524. A second terminal of the second capacitor 524 is coupled to a node between the fifth and sixth switches 550, 552. Thus, as can be seen in FIG. 5, the first and second terminals of each capacitor 522, 524 are each connected to a common node between a respective pair of the switches.

In use of the cell balancing circuitry 500, the first switch network node 530 is coupled to a first terminal of the first cell 512 of the battery pack 510. A first intermediate switch network node 534, between the second switch 544 and the third switch 546, is coupled to a first battery pack node 518, between a second terminal of the first cell 512 and a first terminal of the second cell 514, of the battery pack 510. A second intermediate switch network node 536, between the fourth switch 548 and the fifth switch 550, is coupled to a second battery pack node 520, between a second terminal of the second cell 514 and a first terminal of the third cell 516, of the battery pack 510. The second switch network node 532 is coupled to a second terminal of the third cell 516.

The cell balancing circuitry 500 may operate continuously while the battery pack 510 is discharging in use (e.g. to power a device of the kind discussed above) and/or while the battery pack 510 is charging, or may operate intermittently or periodically during use/discharging and/or charging of the battery pack 510.

In operation of the cell balancing circuitry 500, the switches 542-552 are controlled by the control circuitry 560 to switch on and off in a predefined sequence to charge and discharge the capacitors 522, 524 in order to balance or equalise (at least partially) the voltage and/or stage of charge of the cells 512-516 of the battery pack 510. Operation of the switches is synchronised to a clock signal (not shown) that is received or internally generated by the control circuitry 560.

Assuming all of the switches 542-552 are initially open, during a first phase ϕ1 of operation of the cell balancing circuitry 500 (which is synchronised to a first cycle of the clock signal) the first, third and fifth switches 542, 546, 550 are closed, in response to control signals from the control circuitry 560, and the other switches of the switch network remain open.

Thus, during the first phase, the first cell 512 of the battery pack 510 is coupled in parallel with the first capacitor 522 and the second cell 514 of the battery pack 510 is coupled in parallel with the second capacitor 524. If a voltage V1 across the first cell 510 exceeds a voltage VC1 across the first capacitor 522, current will flow from the first cell 512 to the first capacitor 522, causing the first capacitor 522 to charge up. Conversely, if the voltage VC1 across the first capacitor 522 is greater than the voltage across the first cell 512, current will flow from the first capacitor 522 to the first cell 512, causing the first cell 512 to charge up. Therefore, during the first phase ϕ1 the voltages of the first cell 512 and the first capacitor 522 are at least partially equalised.

Similarly, if a voltage V2 across the second cell 514 exceeds a voltage VC2 across the second capacitor 524, current will flow from the second cell 514 to the second capacitor 524, causing the second capacitor 524 to charge up. Conversely, if the voltage VC2 across the second capacitor 524 is greater than the voltage V2 across the second cell 514, current will flow from the second capacitor 524, to the second cell 514, causing the second cell 514 to charge up. Therefore, during the first phase ϕ1 the voltages of the second cell 514 and the second capacitor 524 are at least partially equalised.

During a second phase ϕ2 of operation of the cell balancing circuitry 500 (which is synchronised to a second cycle of the clock signal) the first, third and fifth switches 542, 546, 550 are opened and the second, fourth and sixth switches 544, 548, 552 are closed (in response to appropriate control signals from the control circuitry 560). Thus, during the second phase, the first capacitor 522 is coupled in parallel with the second cell 514 of the battery pack 510 and the second capacitor 524 is coupled in parallel with the third cell 516 of the battery pack 510. If the voltage VC1 across the first capacitor 522 exceeds a voltage V2 across the second cell 514, current will flow from the first capacitor 522 to the second cell 514, causing the second cell 514 to charge up. Conversely, if the voltage V2 across the second cell 514 is greater than the voltage VC1 across the first capacitor 522, current will flow from the second cell 514 to the first capacitor 522, causing the first capacitor 522 to charge up. Therefore, during the second phase ϕ2 the voltages of the second cell 514 and the first capacitor 522 are at least partially equalised. Similarly, if the voltage VC2 across the second capacitor 524 exceeds a voltage V3 across the third cell 516, current will flow from the second capacitor 524 to the third cell 516, causing the third cell 516 to charge up. Conversely, if the voltage V2 across the third cell 516 is greater than the voltage VC2 across the second capacitor 524, current will flow from the third cell 516 to the second capacitor 524, causing the second capacitor 524 to charge up. Therefore, during the second phase ϕ2 the voltages of the third cell 516 and the second capacitor 524 are at least partially equalised.

As will be appreciated by those of ordinary skill in the art, the voltages of the respective cells (512-516) and the respective capacitors (522 and 524) will be dependent on the duration of the respective phases ϕ1-ϕ2.

Thus, over the course of the two sequential phases ϕ1-ϕ2 the following first sequence of couplings occurs: first cell 512 to first capacitor 522 and second cell 514 to second capacitor 524 (ϕ1); first capacitor 522 to second cell 514 (ϕ2) and second capacitor 524 to third cell 516 (ϕ2). This first sequence may be repeated during operation of the cell balancing circuitry 500, or alternatively a second sequence in which the order of the couplings is reversed may follow the first sequence, i.e. at the end of the first sequence, the following second sequence of couplings may occur over the course of a further two sequential phases of operation ϕ3-ϕ4: third cell 516 to second capacitor 524 and second cell 514 to first capacitor 522 (ϕ3); second capacitor 524 to second cell 514 and first capacitor 522 to first cell 512 (ϕ4). At the end of the second sequence the first sequence of couplings may be repeated. As will be appreciated, the state (open/closed) of the switches 542-552 in the third phase ϕ3 is the same as the state of the switches in the second phase ϕ2, the state of the switches 542-552 in the fourth phase ϕ4 is the same as the state of the switches in the first phase ϕ1. Thus the second sequence of couplings is the inverse of the first sequence of couplings.

As will be appreciated, over the course of one or more sequences of couplings, charge can be transferred between the cells 512-516 and the capacitors 522, 524, thus moving charge sequentially from one cell to an adjacent cell (which may be above or below the one cell in the battery back 510) to balance or equalise (at least partially) a state of charge and/or voltage of the cells 512-516. It will be appreciated, however, that balancing or equalising the cells in this way can take a significant amount of time, particularly where the battery pack comprises longer strings of series-connected cells, e.g. 16 (or more) cells connected in series.

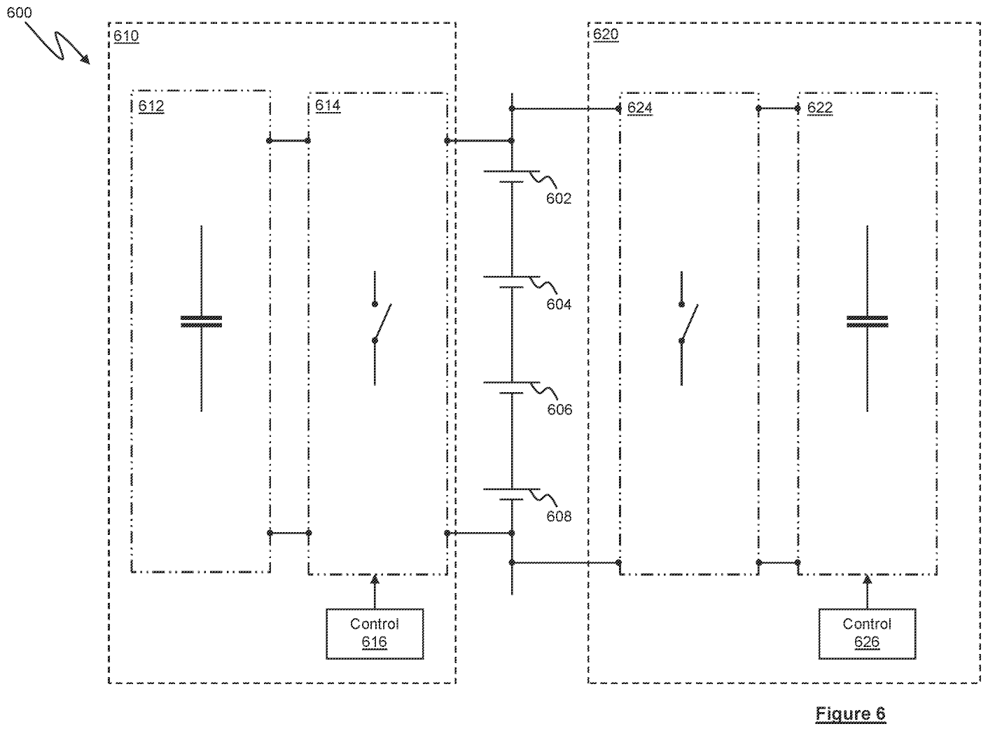

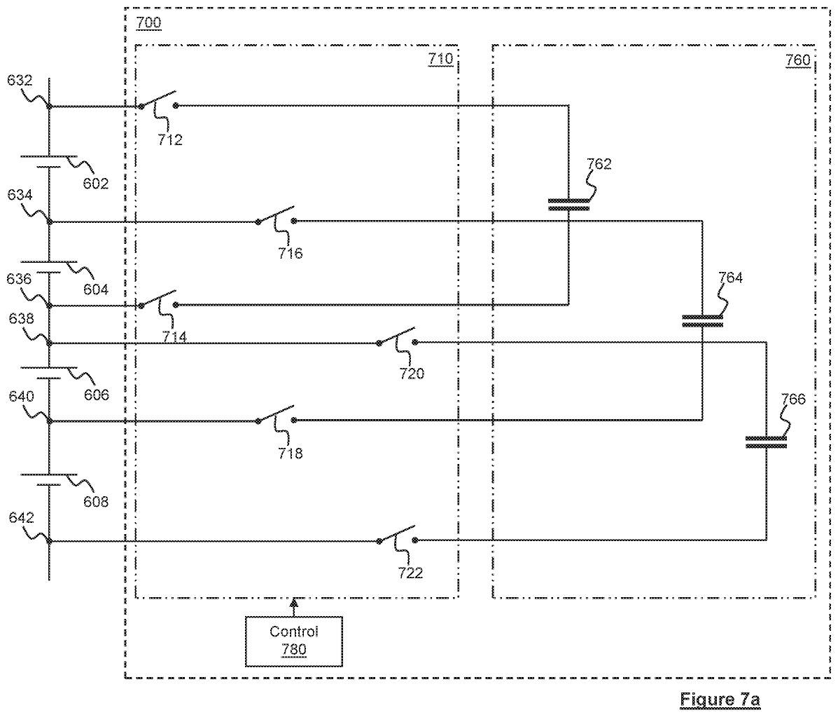

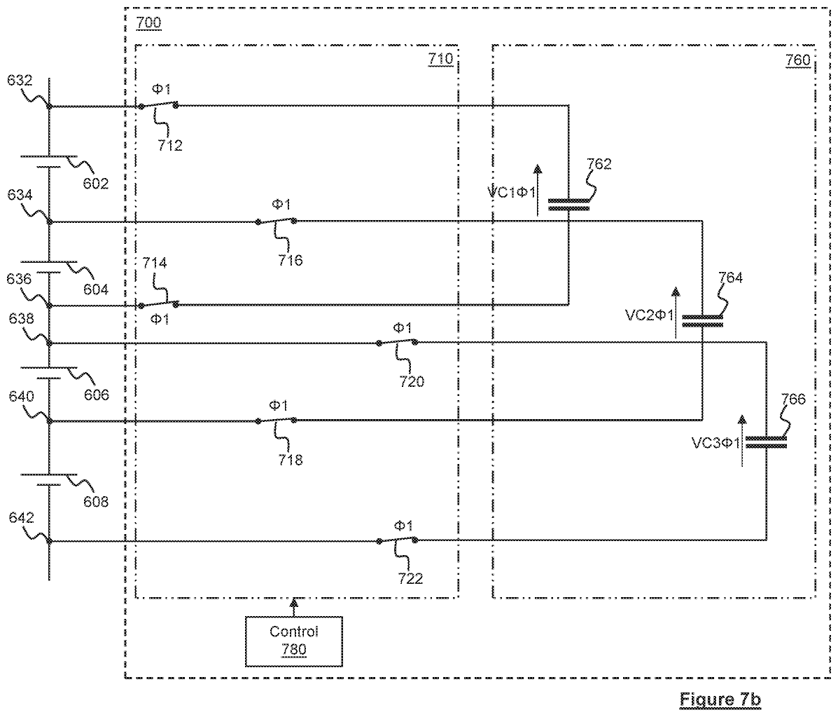

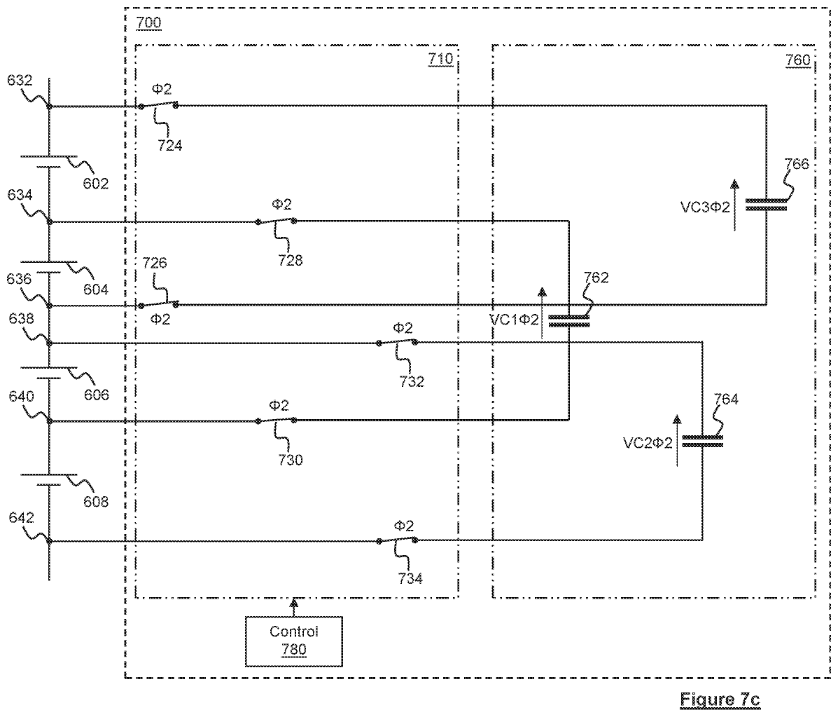

FIG. 6 is a schematic diagram illustrating a cell balancing system for balancing a set of series-connected cells 602-608 (e.g. in a module, battery or battery pack) according to the present disclosure.

The cell balancing system, shown generally at 600 in FIG. 6, comprises first balancer circuitry 610 and second balancer circuitry 620 for coupling to the set of series-connected cells 602-608.

The first balancer circuitry 610 comprises a first set of one or more capacitors 612, a first switch network 614 comprising a plurality of switches, and first control circuitry 616. In use of the cell balancing system 600 the first and second balancer circuitry 610, 620 operate simultaneously to balance or equalise, at least partially, a voltage and/or state of charge of the cells 602-608.

In operation of the cell balancing system 600, the first switch network 614 is coupled to the set of series-connected cells 602-608 and to the first set of capacitors 612, and is operable, under the control of the first control circuitry 616, to balance or equalise, at least partially, a state of charge (SoC) and/or voltage between the cells 602-608 by transferring charge from one cell to another cell.

Thus, in operation of the first balancer circuitry 610, the switches of the first switch network 614 are controlled by the first control circuitry 616 to switch on and off in a predefined sequence to couple one or more of the capacitors of the first set of capacitors 612 to a first one of the cells 602-608 during a first phase of operation of the first balancer circuitry 610, and to couple the one or more capacitors to a second one of the cells during a second phase of operation of the first balancer circuitry 610. Operation of the switches is synchronised to a clock signal (not shown) that is received or internally generated by the first control circuitry 616.

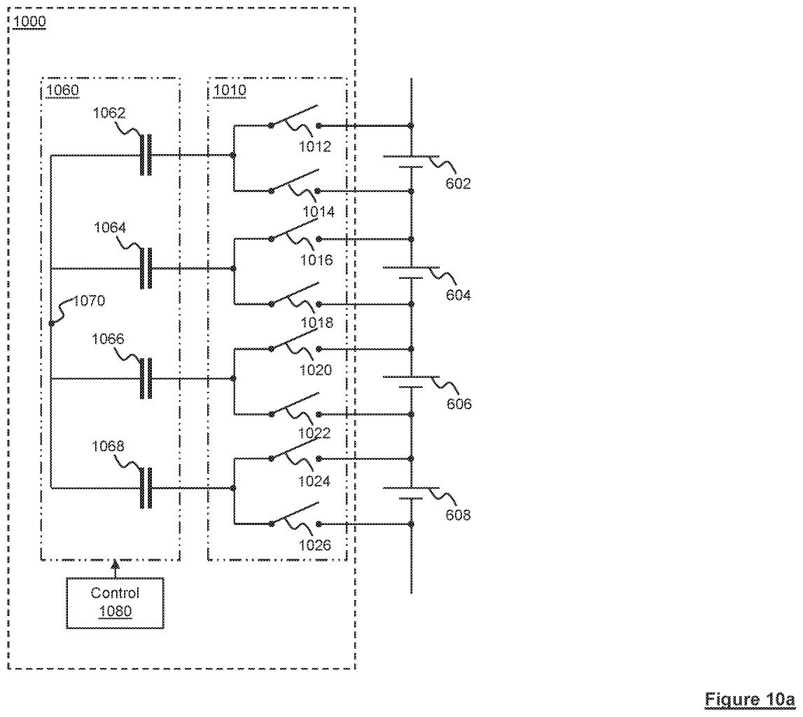

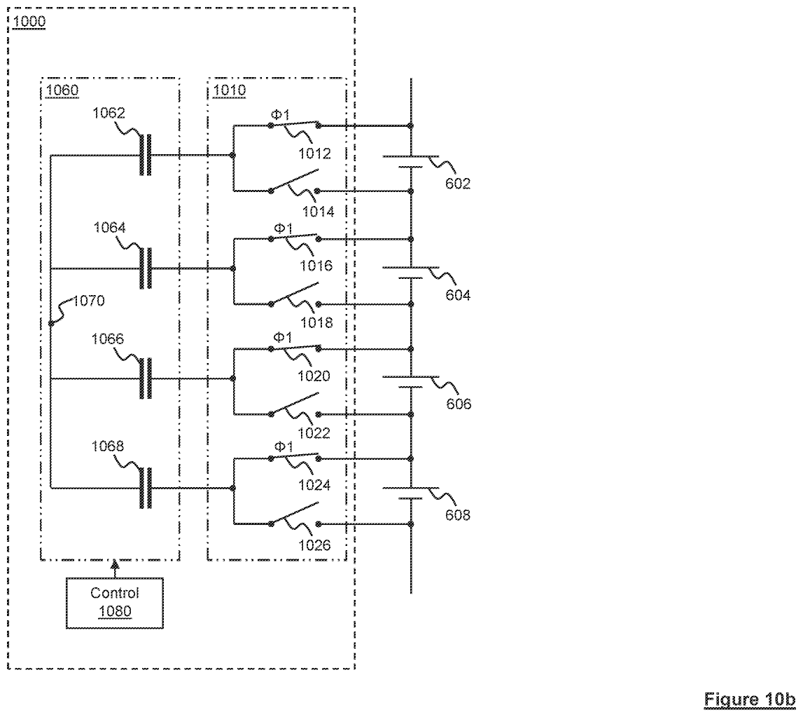

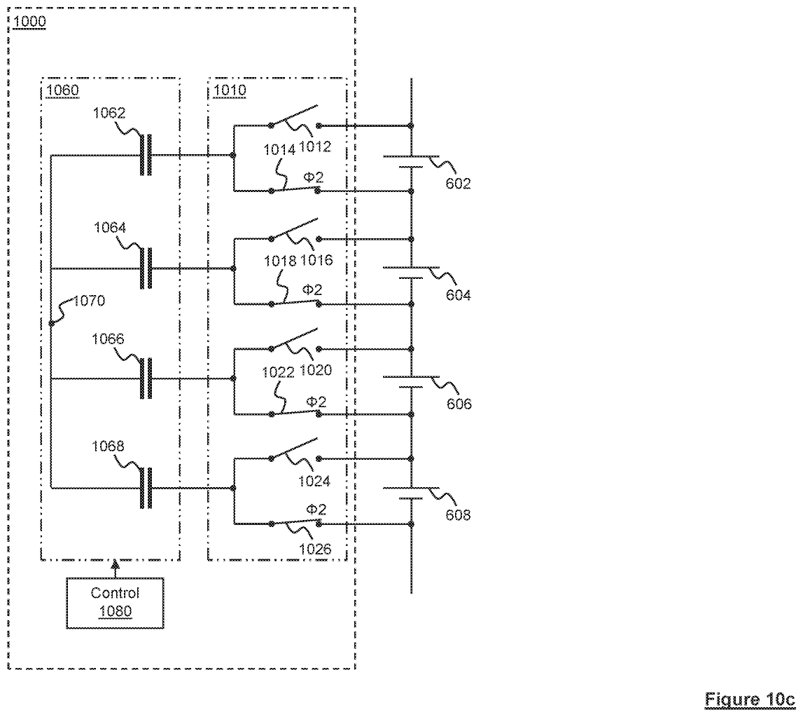

The first balancer circuitry 610 may be implemented in a number of different ways. For example, the first balancer circuitry 610 may be implemented using circuitry of the kind described above with reference to FIG. 5, or of the kind described below with reference to FIGS. 10a-10c. In each implementation of the first balancer circuitry 610, charge is transferred between individual cells via one or more capacitors.

The second balancer circuitry 620 comprises a second set of one or more capacitors 622, a second switch network 624 comprising a plurality of switches, and second control circuitry 626.

In use of the cell balancing system 600 the second switch network 624 is coupled to the set of series-connected cells 602-608 and to the second set of capacitors 622, and is operable, under the control of the second control circuitry 626, to balance or equalise, at least partially, a state of charge (SoC) and/or voltage between the cells 602-608 by transferring charge between different subsets of the set of series-connected cells.

Thus, in operation of the second balancer circuitry 620, the switches of the second switch network 624 are controlled by the second control circuitry 626 to switch on and off in a predefined sequence to couple one or more of the capacitors of the second set of capacitors 622 to a first subset comprising two or more of the cells 602-608 during a first phase of operation of the second balancer circuitry 620, and to couple the one or more capacitors to a second subset (different from the first subset) comprising two or more of the cells 602-608 during a second phase of operation of the second balancer circuitry 620. Operation of the switches is synchronised to a clock signal (not shown) that is received or internally generated by the control circuitry 626.

The second balancer circuitry 620 may be implemented in a number of different ways (examples of which are described below), but in each implementation one or more capacitors are coupled to a first subset of two or more series-connected cells 602-608 during a first phase of operation, and to a second subset of two or more series connected cells 602-608 during a second or subsequent phase of operation.

By coupling the capacitor(s) to two or more series-connected cells per phase in this way, the total capacitance “seen” by the capacitor(s) is lower than the capacitance that would be “seen” by the capacitor(s) if they were coupled to a single cell, since the total capacitance of multiple cells connected in series is less than the capacitance of any one of those cells, and this reduced total capacitance leads to a reduction in the time it takes to balance or equalise the voltage and/or state of charge between the cells of the set, as compared to the time taken to balance or equalise the voltage and/or state of charge when charge is transferred between individual cells.

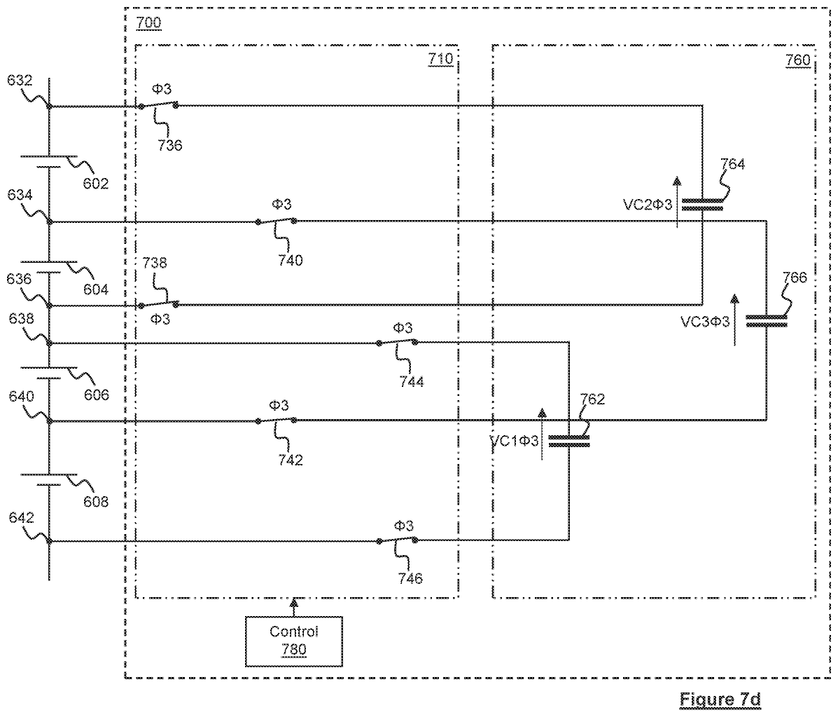

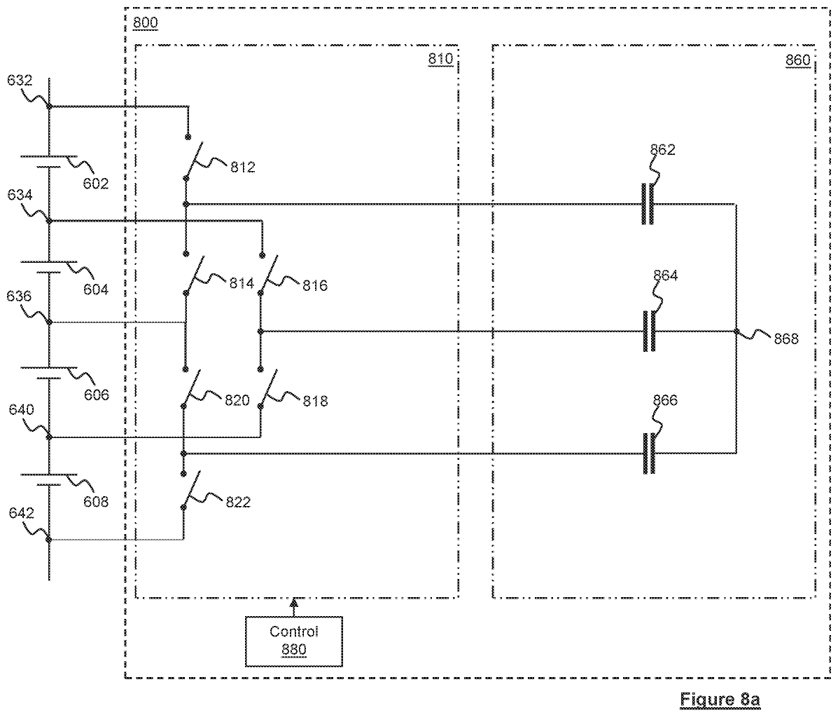

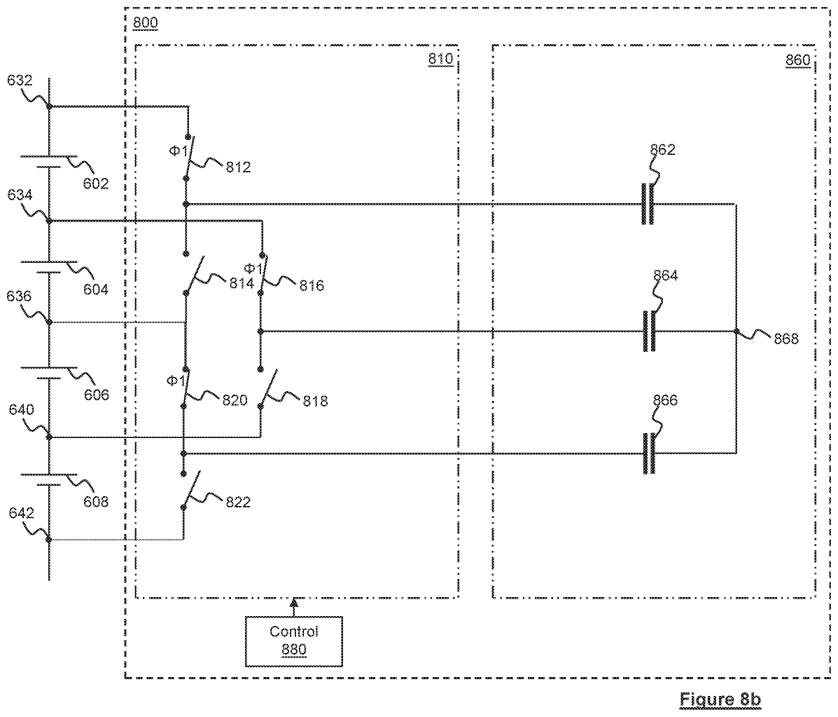

FIG. 7a is a schematic diagram illustrating an implementation of second balancer circuitry for use in the cell balancing system of FIG. 6. In the illustrated implementation the second balancer circuitry (shown generally at 700) comprises a switch network 710, a set of capacitors 760 and control circuitry 780.

The switch network 710 in the illustrated example comprises a first pair of switches 712, 714 for coupling a first capacitor 762 of the set of capacitors in parallel with a series combination of the first and second cells 602, 604 of the set of cells. The switch network 710 further comprises a second pair of switches 716, 718 for coupling a second capacitor 764 of the set of capacitors in parallel with a series combination of the second and third cells 604, 606 of the set of cells, and a third pair of switches 720, 722 for coupling a third capacitor 766 of the set of capacitors in parallel with a series combination of the third and fourth cells 606, 608 of the set of cells.

Additionally, the switch network 710 comprises a fourth pair of switches 724, 726 for coupling the third capacitor 766 in parallel with the series combination of the first and second cells 602, 604, a fifth pair of switches 728, 730 for coupling the first capacitor 762 in parallel with the series combination of the second and third cells 604, 606, and a sixth pair of switches 732, 734 for coupling the second capacitor 764 in parallel with the series combination of the third and fourth cells 606, 608. For clarity the fourth, fifth and sixth pairs of switches are not shown in FIG. 7a, but are shown in FIG. 7c, and their operation will be discussed below.

The switch network 710 comprises a seventh pair of switches 736, 738 for coupling the second capacitor 764 in parallel with the series combination of the first and second cells 602, 604, an eighth pair of switches 740, 742 for coupling the third capacitor 766 in parallel with the series combination of the second and third cells 604, 606, and a ninth pair of switches 744, 746 for coupling the first capacitor 762 in parallel with the series combination of the third and fourth cells 606, 608. For clarity the seventh, eighth and ninth pairs of switches are not shown in FIG. 7a, but are shown in FIG. 7d, and their operation will be discussed below.

The switches 712-746 may be electrically controllable switching devices such as MOSFETs, for example. The control circuitry 780 may be implemented by a microprocessor, microcontroller, state machine or the like.

The second balancer circuitry 700 may operate continuously while the set of cells 602-608 is discharging in use (e.g. to power a device of the kind discussed above) and/or while the set of cells 602-608 is charging, or may operate intermittently or periodically during use/discharging and/or charging of the set of cells 602-608.

In operation of the second balancer circuitry 700, the switch network 710 is coupled to first to sixth nodes 632-642 of the set of cells 602-608, and the switches 712-746 are controlled by the control circuitry 780 to switch on and off in a predefined sequence to charge and discharge the capacitors 762-766 in order to balance or equalise (at least partially) the voltage and/or stage of charge of the cells 602-608. Operation of the switches is synchronised to a clock signal (not shown) that is received or internally generated by the control circuitry 780. Note that for clarity and ease of explanation FIG. 7a shows six nodes 632-642, but it will be appreciated that as the third and fourth nodes 636, 638 are both located between a second terminal of the second cell 604 and a first terminal of the third cell 606, the third and fourth nodes 636, 638 are effectively the same node.

The operation of the second balancer circuitry 700 will now be described with reference to FIGS. 7b-7d.

Assuming all of the switches 712-746 are initially open, during a first phase ϕ1 of operation of the second balancer circuitry 700 (which is synchronised to a first cycle of the clock signal) the first, second and third pairs of switches 712-722 are closed (as shown in FIG. 7b), in response to control signals from the control circuitry 780, and the other switches of the switch network 710 remain open. Thus, during the first phase ϕ1, the first capacitor 762 is coupled in parallel with the series combination of the first cell 602 and the second cell 604, the second capacitor 764 is coupled in parallel with the series combination of the second cell 604 and the third cell 606, and the third capacitor 766 is coupled in parallel with the series combination of the third cell 606 and the fourth cell 608.

If a voltage at the first node 632 (which is coupled to a first terminal of the first cell 602) relative to the third node 636 during the first phase ϕ1 exceeds a voltage VC1ϕ1 across the first capacitor 762, current will flow from the first and second cells 602, 604 to the first capacitor 762, causing the first capacitor 762 to charge up. Conversely, if the voltage VC1ϕ1 across the first capacitor 762 exceeds the voltage at the first node 632 relative to the third node 636, current will flow from the first capacitor 762 into the first and second cells 602, 604 causing the first and second cells 602, 604 to charge up.

Similarly, if a voltage at the second node 634 (which is coupled to a second terminal of the first cell 602 and to a first terminal of the second cell 604) relative to the fifth node 640 during the first phase ϕ1 exceeds a voltage VC2ϕ1 across the second capacitor 764, current will flow from the second and third cells 604, 606 to the second capacitor 764, causing the second capacitor 764 to charge up. Conversely, if the voltage VC2ϕ1 across the second capacitor 764 exceeds the voltage at the second node 634 relative to the fifth node 640, current will flow from the second capacitor 764 into the second and third cells 604, 606, causing the second and third cells 604, 606 to charge up.

Likewise, if a voltage at the fourth node 638 (which is coupled to a second terminal of the second cell 604 and to a first terminal of the third cell 606) relative to the sixth node 642 during the first phase ϕ1 exceeds a voltage VC3ϕ1 across the third capacitor 766, current will flow from the third and fourth cells 606, 608 to the third capacitor 766, causing the third capacitor 766 to charge up. Conversely, if the voltage VC3ϕ1 across the third capacitor 766 exceeds the voltage at the fourth node 638, current will flow from the third capacitor 766 into the third and fourth cells 606, 608, causing the third and fourth cells 606, 608 to charge up.

During a second phase ϕ2 of operation of the second balancer circuitry 700 (which is synchronised to a second cycle of the clock signal) the fourth, fifth and sixth pairs of switches 724-734 are closed (as shown in FIG. 7c), in response to control signals from the control circuitry 780, and the other switches of the switch network 710 are opened (or remain open). Thus, during the second phase ϕ2, the third capacitor 766 is coupled in parallel with the series combination of the first cell 602 and the second cell 604, the first capacitor 762 is coupled in parallel with the series combination of the second cell 604 and the third cell 606, and the second capacitor 764 is coupled in parallel with the series combination of the third cell 606 and the fourth cell 608.

If a voltage at the first node 632 relative to the third node 636 during the second phase ϕ2 exceeds a voltage VC3ϕ2 across the third capacitor 766, current will flow from the first and second cells 602, 604 to the third capacitor 766, causing the third capacitor 766 to charge up. Conversely, if the voltage VC3ϕ2 across the third capacitor 766 exceeds the voltage at the first node 632 relative to the third node 636, current will flow from the third capacitor 766 into the first and second cell 602, 604 causing the first and second cells 602, 604 to charge up. Thus, during the second phase ϕ2 the first cell and second cells 602, 604 may receive charge taken from the third and fourth cells 606, 608 during the first phase ϕ1, or may supply charge to the third capacitor 766.

Similarly, if a voltage at the second node 634 relative to the fifth node 640 during the second phase ϕ2 exceeds a voltage VC1ϕ2 across the first capacitor 762, current will flow from the second and third cells 604, 606 to the first capacitor 762, causing the first capacitor 762 to charge up. Conversely, if the voltage VC1ϕ2 across the first capacitor 762 exceeds the voltage at the second node 634 relative to the fifth node 640, current will flow from the first capacitor 762 into the second and third cells 604, 606, causing the second and third cells 604, 606 to charge up. Thus, during the second phase ϕ2 the second and third cells 604, 606 may receive charge taken from the first and second cells 602, 604 during the first phase ϕ1, or may supply charge to the first capacitor 762.

Likewise, if a voltage at the fourth node 638 relative to the sixth node 642 during the second phase ϕ2 exceeds a voltage VC2ϕ2 across the second capacitor 764, current will flow from the third and fourth cells 606, 608 to the second capacitor 764, causing the second capacitor 764 to charge up. Conversely, if the voltage VC2ϕ2 across the second capacitor 764 exceeds the voltage at the fourth node 638 relative to the sixth node 642, current will flow from the second capacitor 764 into the third and fourth cells 606, 608, causing the third and fourth cells 606, 608 to charge up. Thus, during the second phase ϕ2 the third and fourth cells 606, 608 may receive charge taken from the second and third cells 604, 606 during the first phase ϕ1, or may supply charge to the second capacitor 764.

During a third phase ϕ3 of operation of the second balancer circuitry 700 (which is synchronised to a third cycle of the clock signal) the seventh, eighth and ninth pairs of switches 736-746 are closed (as shown in FIG. 7d), in response to control signals from the control circuitry 780, and the other switches of the switch network 710 are opened (or remain open). Thus, during the third phase ϕ3, the second capacitor 764 is coupled in parallel with the series combination of the first cell 602 and the second cell 604, the third capacitor 766 is coupled in parallel with the series combination of the second cell 604 and the third cell 606, and the first capacitor 762 is coupled in parallel with the series combination of the third cell 606 and the fourth cell 608.

If a voltage at the first node 632 relative to the fourth node 638 during the third phase ϕ3 exceeds a voltage VC2ϕ3 across the second capacitor 764, current will flow from the first and second cells 602, 604 to the second capacitor 764, causing the second capacitor 764 to charge up. Conversely, if the voltage VC2ϕ3 across the second capacitor 764 exceeds the voltage at the first node 632 relative to the fourth node 638, current will flow from the second capacitor 764 into the first and second cells 602, 604, causing the first and second cells 602, 604 to charge up. Thus, during the third phase ϕ3 the first and second cells 602, 604 may receive charge taken from the third and fourth cells 606, 608 during the second phase ϕ2, or may supply charge to the second capacitor 764.

Similarly, if a voltage at the second node 634 relative to the fifth node 640 during the third phase ϕ3 exceeds a voltage VC3ϕ3 across the third capacitor 766, current will flow from the second and third cells 604, 606 to the third capacitor 766, causing the third capacitor 766 to charge up. Conversely, if the voltage VC3ϕ3 across the third capacitor 766 exceeds the voltage at the second node 634 relative to the fifth node 640, current will flow from the third capacitor 766 into the second and third cells 604, 606, causing the second and third cells 604, 606 to charge up. Thus, during the third phase ϕ3 the second and third cells 604, 606 may receive charge taken from the first and second cells 602, 604 during the second phase ϕ2, or may supply charge to the third capacitor 766.

Likewise, if a voltage at the fourth node 638 relative to the sixth node 642 during the third phase ϕ3 exceeds a voltage VC1ϕ3 across the first capacitor 762, current will flow from the third and fourth cells 606, 608 to the first capacitor 762, causing the first capacitor 762 to charge up. Conversely, if the voltage VC1ϕ3 across the first capacitor 762 exceeds the voltage at the fourth node 638 relative to the sixth node 642, current will flow from the first capacitor 762 into the third and fourth cells 606, 608, causing the third and fourth cells 606, 608 to charge up. Thus, during the third phase ϕ3 the third and fourth cells 606, 608 may receive charge taken from the second and third cells 604, 606 during the second phase ϕ2, or may supply charge to the first capacitor 762.

The second balancer circuitry 700 may cycle through the first, second and third phases sequentially. In the illustrated example each of the capacitors 762-766 is coupled in parallel with a series combination of two of the cells in each phase. Thus, each capacitor 762-766 “sees” a lower cell capacitance than it would “see” if it were coupled to a single cell, and so the transfer of charge from the capacitors 762-766 to the cells 602-608 to balance or equalise the voltage and/or state of charge of the cells 602-608 occurs more quickly than it would if each capacitor 762-766 were coupled to a single cell in each phase.

In the illustrated example the set of cells comprises four cells 602-608 and the set of capacitors 760 comprises three capacitors 762-766. More generally, for second balancer circuitry of the kind illustrated in FIG. 7a, the set of capacitors 760 may comprise between 1 and N−1 capacitors, where N is the number of cells in the set of series-connected cells.

In the illustrated example the switch network 710 comprises a pair of switches for each capacitor 762-766 for each of the three possible subsets of two of the set of series-connected cells 602-608, making a total of 18 switches. One operational cycle of the second balancer circuitry comprises a sequence of three phases. Over the course of the sequence of three phases, each capacitor 762-766 is coupled once to each of the three possible subsets comprising two of the set of series-connected cells 602-608.

More generally, for second balancer circuitry of the kind illustrated in FIG. 7a in which each capacitor 762-766 is coupled to a series combination of two of the cells 602-608 per phase (i.e. where balancing is carried out on a subset-by-subset basis for the set of series-connected cells, where each subset comprises two of the set of series-connected cells), the switch network comprises 2(N−1)² switches, the set of capacitors comprises N−1 capacitors, and each capacitor of the set of capacitors is associated with 2(N−1) switches of the switch network. One operational cycle of the second balancer circuitry comprises a sequence of N−1 phases, and over the course of an operational cycle of the second balancer circuitry, each capacitor of the set of capacitors is coupled once to each of the N−1 possible subsets comprising two of the set of series-connected cells 602-608.

Even more generally, for second cell balancer circuitry of the kind illustrated in FIG. 7a in which each capacitor of a set of one or more capacitors is coupled to a subset comprising a series combination of two or more cells of a set of N cells per phase, one operational cycle comprises a sequence of M phases, where M is the number of subsets of the set of N cells, and over the course of an operational cycle of the second balancer circuitry, each capacitor of the set of capacitors is coupled once to each of the M subsets of cells.

Thus, for a set of four cells having two subsets (i.e. [cell 1, cell 2, cell 3], [cell 2, cell 3, cell 4]), one operational cycle comprises a sequence of two phases. For a set of four cells having three subsets (i.e. [cell 1, cell 2], [cell 2, cell 3], [cell 3, cell 4]), as in the example shown in FIG. 7a, one operational cycle comprises a sequence of three phases. For a set of five cells having four subsets (i.e. [cell 1, cell 2], [cell 2, cell 3], [cell 3, cell 4], [cell 4, cell 5]), one operational cycle comprises a sequence of four phases. For a set of five cells having three subsets (i.e. [cell 1, cell 2, cell 3], [cell 2, cell 3, cell 4], [cell 3, cell 4, cell 5]), one operational cycle comprises a sequence of three phases.

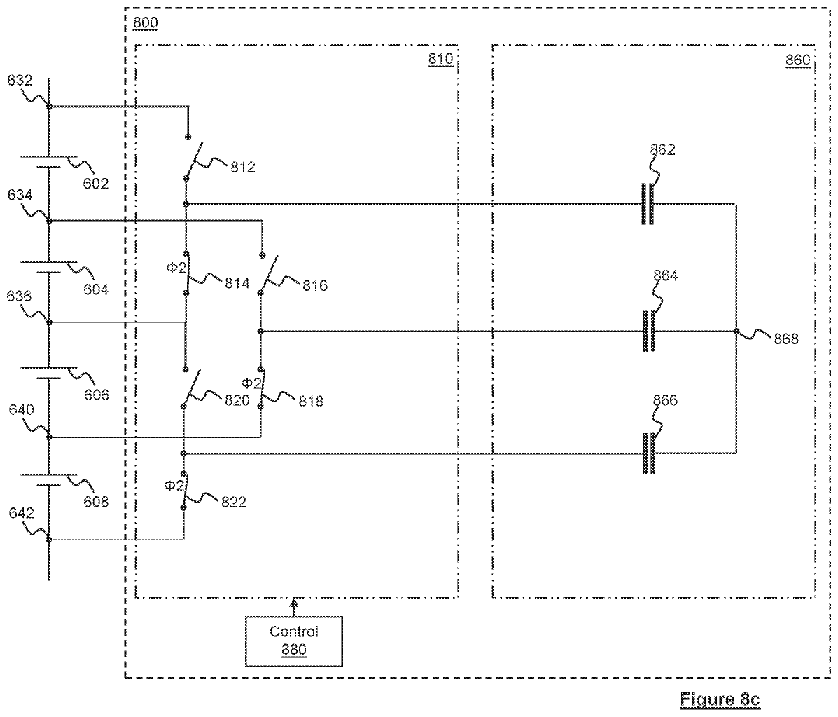

FIG. 8a is a schematic diagram illustrating an alternative implementation of second balancer circuitry for use in the cell balancing system of FIG. 6. In the illustrated implementation the second balancer circuitry (shown generally at 800) comprises a switch network 810, a set of capacitors 860 and control circuitry 880.

The switch network in this example comprises first to sixth switches 812-822, which may be electrically controllable switching devices such as MOSFETs, for example.

The set of capacitors 860 comprises a plurality (in this example three) of capacitors 862-866 coupled in parallel between the switch network 810 and a common node 868, such that in operation of the second balancer circuitry 800 the first switch 812 is coupled between the first node 632 of the set of cells and a first terminal of a first capacitor 862 of the set of capacitors.

The second switch 814 is coupled between the third node 636 of the set of cells and the first terminal of the first capacitor 862.

The third switch 816 is coupled between the second node 634 and a first terminal of a second capacitor 864 of the set of capacitors.

The fourth switch 818 is coupled between the fifth node 640 of the set of cells and the first terminal of the second capacitor 864.

The fifth switch 820 is coupled between the third node 636 of the set of cells and a first terminal of a third capacitor 866 of the set of capacitors.

The sixth switch 822 is coupled between the sixth node 642 of the set of cells and the first terminal of the third capacitor 866.

Second terminals of the first, second and third capacitors 862-866 are coupled to the common node 868.

The control circuitry 880 may be implemented by a microprocessor, microcontroller, state machine or the like.

The second balancer circuitry 800 may operate continuously while the set of cells 602-608 is in use (e.g. to power a device of the kind discussed above) and/or while the set of cells 602-608 is charging, or may operate intermittently or periodically during use and/or charging the set of cells 602-608.

In operation of the second balancer circuitry 800, the switches 812-822 are controlled by the control circuitry 880 to switch on and off in a predefined sequence to charge and discharge the capacitors 862-866 in order to balance or equalise (at least partially) the cells 602-608. Operation of the switches 812-822 is synchronised to a clock signal that is received or internally generated by the control circuitry 880.

Assuming all of the switches 812-822 are initially open, then during a first phase ϕ1 of operation of the second balancer circuitry 800 (which is synchronised to a first cycle of the clock signal), the first, third and fifth switches 812, 816, 820 are closed (as shown in FIG. 8b), in response to control signals from the control circuitry 880, and the other switches of the switch network 810 remain open.

Thus, during the first phase ϕ1, the first and third capacitors 862, 866 are coupled to a series combination of the first cell 602 and the second cell 604, the first and second capacitors 862, 864 are coupled to the first cell 602, and the second and third capacitors 864, 866 are coupled to the second cell 604.

Current can therefore flow between the first and second cells 602, 604 and the capacitors 862, 866 during the first phase. The direction of current flow will depend upon the voltage across each of the first and second cells 602, 604 and across each of the capacitors 862, 866. For example, if at the start of the first phase the first and second cells 802, 804 are at a relatively high voltage or state of charge and the first and third capacitors 862, 866 are at a relatively low voltage or state of charge, then during the first phase current will flow from the first and second cells 602, 604 to the capacitors 862, 866, thereby charging the capacitors 862, 866.

During a second phase ϕ2 of operation of the second balancer circuitry 800 (which is synchronised to a second cycle of the clock signal), the second, fourth and sixth switches 814, 818, 822 are closed (as shown in FIG. 8c), in response to control signals from the control circuitry 880, and the other switches of the switch network 810 are opened. Thus, during the second phase ϕ2, the first and third capacitors 862, 866 are coupled to a series combination of the third cell 606 and the fourth cell 608.

Current can therefore flow between the third and fourth cells 606, 608 and the capacitors 862, 866. Again, the direction of current flow will depend upon the voltage across each of the third and fourth cells 606, 608 and across each of the capacitors 862, 866. For example, if at the start of the second phase the first and third capacitors 862, 866 are at a relatively high voltage or state of charge and the third and fourth cells 606, 608 are at a relatively low voltage or state of charge, then during the second phase, current will flow from the capacitors 862, 866 to the third and fourth cells 606, 608, thereby charging the third and fourth cells 606, 608.

As will be appreciated, in the second balancer circuitry 800 shown in FIGS. 8a-8c charge is transferred between different subsets of the set of cells 602-608 and the capacitors 862-866 in consecutive phases ϕ1, ϕ2. As described above, during the first phase the first and third capacitors 862, 866 are coupled to the series combination of the first and second cells 602, 604 and during the second phase the first and third capacitors 862, 866 are coupled to the series combination of the third and fourth cells 606, 608. The effective capacitance of these series combinations of cells is less than the capacitance of any individual cell, and so transfer of charge from the capacitors 862, 866 to the cells can take place more quickly than would be possible if the capacitors were coupled only to a single cell.

In the illustrated example the set of cells comprises four cells 602-608, the set of capacitors 860 comprises three capacitors 862-866, and the switch network 810 comprises six switches 812-822. More generally, for second balancer circuitry of the kind illustrated in FIG. 8a, the set of capacitors 860 comprises N−1 capacitors and the switch network comprises 2(N−1) switches, where N is the number of cells in the set of series-connected cells.

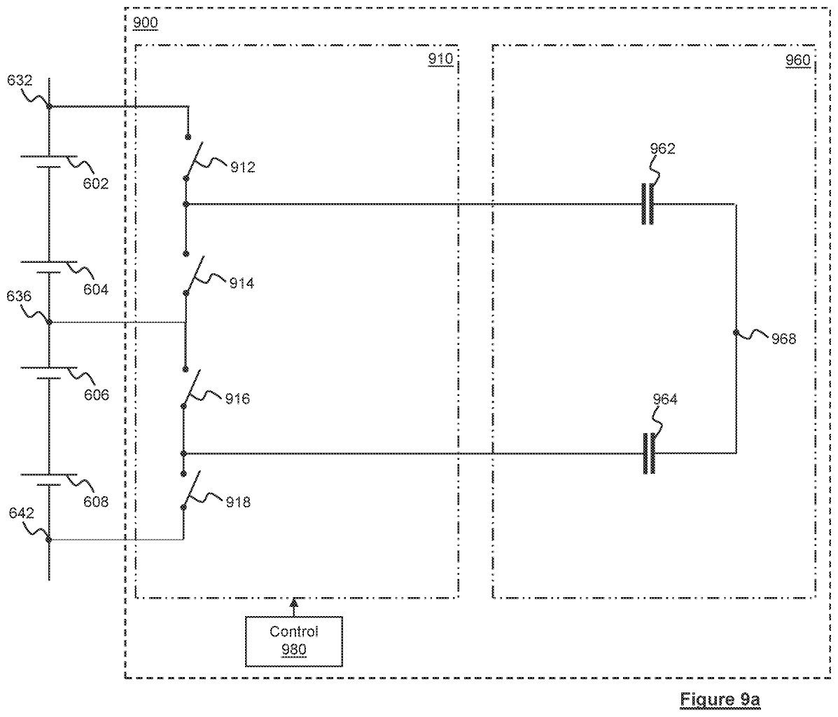

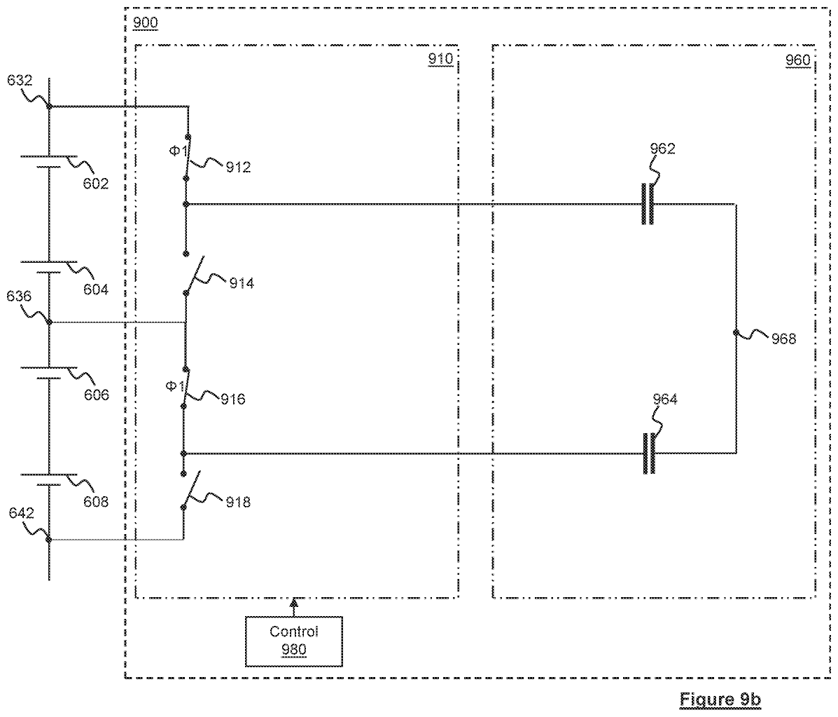

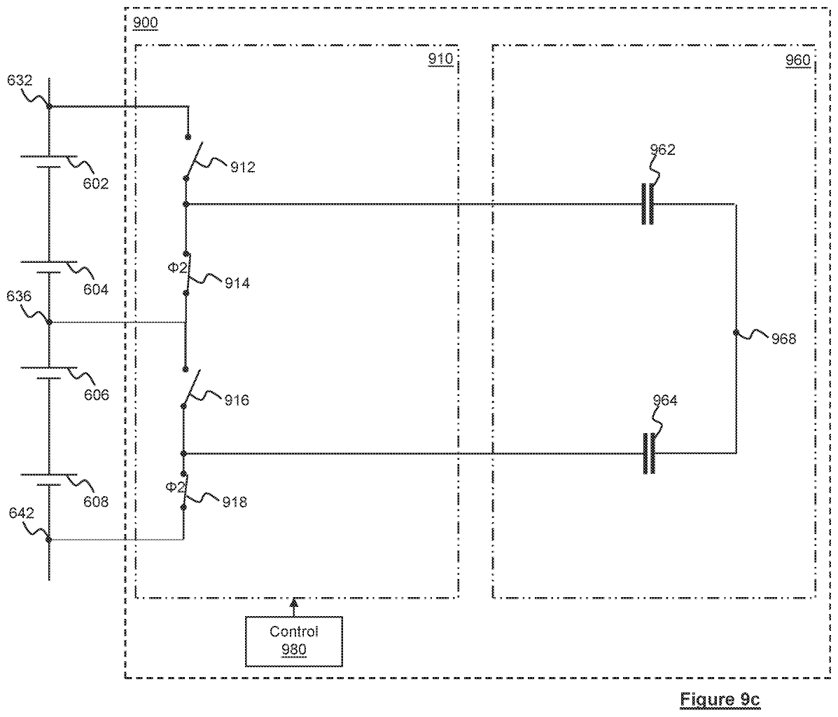

FIG. 9a is a schematic diagram illustrating a further alternative implementation of second balancer circuitry for use in the cell balancing system of FIG. 6. In the illustrated implementation the second balancer circuitry (shown generally at 900) comprises a switch network 910, a set of capacitors 960 and control circuitry 980.

The switch network in this example comprises first to fourth switches 912-918, which may be electrically controllable switching devices such as MOSFETs, for example.

In operation of the second balancer circuitry 900 the first switch 912 is coupled between the first node 632 of the set of cells and a first terminal of a first capacitor 962 of the set of capacitors. The second switch 914 is coupled between the third node 636 of the set of cells and the first terminal of the first capacitor 962. The third switch 916 is coupled between the third node 636 of the set of cells and a first terminal of a second capacitor 964 of the set of capacitors. The fourth switch 918 is coupled between the sixth node 642 of the set of cells and the first terminal of the second capacitor 964.

Second terminals of the first and second capacitors 962, 964 are coupled to a common node 968.

The control circuitry 980 may be implemented by a microprocessor, microcontroller, state machine or the like.

The second balancer circuitry 900 may operate continuously while the set of cells 602-608 is in use (e.g. to power a device of the kind discussed above) and/or while the set of cells 602-608 is charging, or may operate intermittently or periodically during use and/or charging the set of cells 602-608.

In operation of the second balancer circuitry 900, the switches 912-918 are controlled by the control circuitry 980 to switch on and off in a predefined sequence to charge and discharge the capacitors 962, 964 in order to balance or equalise (at least partially) the cells 602-608. Operation of the switches is synchronised to a clock signal that is received or internally generated by the control circuitry 980.

Assuming all of the switches 912-918 are initially open, then during a first phase ϕ1 of operation of the second balancer circuitry 900 (which is synchronised to a first cycle of the clock signal), the first and third switches 912, 916 are closed (as shown in FIG. 9b), in response to control signals from the control circuitry 980, and the other switches of the switch network 910 remain open.

Thus, during the first phase ϕ1, a series combination of the first and second capacitors 962, 964 is coupled in parallel with a series combination of the first cell 602 and the second cell 604.

Current can therefore flow between the first and second cells 602, 604 and the capacitors 962, 964. The direction of current flow will depend upon the voltage across each of the first and second cells 602, 604 and across each of the capacitors 962, 964. For example, if at the start of the first phase the first and second cells 602, 604 are at a relatively high voltage or state of charge and the first and second capacitors 962, 964 are at a relatively voltage or low state of charge, then during the first phase current will flow from the first and second cells 602, 604 to the capacitors 962, 964, thereby charging the capacitors 962, 964.

During a second phase ϕ2 of operation of the second balancer circuitry 900 (which is synchronised to a second cycle of the clock signal), the second and fourth switches 914, 918 are closed (as shown in FIG. 9c), in response to control signals from the control circuitry 980, and the other switches of the switch network 910 are opened. Thus, during the second phase ϕ2, the series combination of the first and second capacitors 962, 964 is coupled in parallel with a series combination of the third cell 606 and the fourth cell 608.

Current can therefore flow between the third and fourth cells 606, 608 and the capacitors 962, 964. Again, the direction of current flow will depend upon the voltage across each of the third and fourth cells 606, 608 and across each of the capacitors 962, 964. For example, if at the start of the second phase the first and second capacitors 962, 964 are at a relatively high voltage or state of charge and the third and fourth cells 606, 608 are at a relatively low voltage or state of charge, then during the second phase, current will flow from the capacitors 962, 964 to the third and fourth cells 606, 608, thereby charging the third and fourth cells 606, 608.

As will be appreciated, in the second balancer circuitry 900 shown in FIGS. 9a-9c charge is transferred between different subsets of the set of cells 602-608 and the capacitors 962, 964 in consecutive phases ϕ1, ϕ2. As described above, during the first phase the first and second capacitors 962, 964 are coupled to the series combination of the first and second cells 602, 604 and during the second phase the first and second capacitors 962, 964 are coupled to the series combination of the third and fourth cells 606, 608. The effective capacitance of these series combinations of cells is less than the capacitance of any individual cell, and so transfer of charge from the capacitors 962, 964 to the cells can take place more quickly than would be possible if the capacitors were coupled only to a single cell.

In the illustrated example the set of cells comprises four cells 602-608, the set of capacitors 960 comprises two capacitors 962, 964, and the switch network 910 comprises four switches 912-918. More generally, for second balancer circuitry of the kind illustrated in FIG. 9a, the set of capacitors 960 comprises N/2 capacitors and the switch network comprises 2(N/2) switches, where N is the number of cells in the set of series-connected cells, and where N is an integer multiple of 2, i.e. there is always an even number of cells.

FIG. 10a is a schematic diagram illustrating an implementation of first balancer circuitry for use in the cell balancing system of FIG. 6. In the illustrated implementation the first balancer circuitry (shown generally at 1000) comprises a switch network 1010, a set of capacitors 1060 and control circuitry 1080.

The switch network in this example comprises first to eighth switches 1012-1026, which may be electrically controllable switching devices such as MOSFETs, for example.

In operation of the first balancer circuitry 1000 the first switch 1012 is coupled between a first terminal of the first cell 602 of the set of cells and a first terminal of a first capacitor 1062 of the set of capacitors. The second switch 1014 is coupled between a second terminal of the first cell 602 and the first terminal of the first capacitor 1062. The third switch 1016 is coupled between a first terminal of the second cell 604 and a first terminal of a second capacitor 1064 of the set of capacitors. The fourth switch 1018 is coupled between a second terminal of the second cell 604 and the first terminal of the second capacitor 1064. The fifth switch 1020 is coupled between a first terminal of the third cell 606 and a first terminal of a third capacitor 1066 of the set of capacitors. The sixth switch 1022 is coupled between a second terminal of the third cell 606 and the first terminal of the third capacitor 1066. The seventh switch 1024 is coupled between a first terminal of the fourth cell 608 and a first terminal of a fourth capacitor 1068 of the set of capacitors. The eighth switch 1026 is coupled between a second terminal of the fourth cell 608 and the first terminal of the fourth capacitor 1068.

Second terminals of the first to fourth capacitors 1062-1068 are coupled to a common node 1070.

The control circuitry 1080 may be implemented by a microprocessor, microcontroller, state machine or the like.

The first balancer circuitry 1000 may operate continuously while the set of cells 602-608 is in use (e.g. to power a device of the kind discussed above) and/or while the set of cells 602-608 is charging, or may operate intermittently or periodically during use and/or charging the set of cells 602-608.

In operation of the first balancer circuitry 1000, the switches 1012-1026 are controlled by the control circuitry 1080 to switch on and off in a predefined sequence to charge and discharge the capacitors 1062-1068 in order to balance or equalise (at least partially) the cells 602-608. Operation of the switches is synchronised to a clock signal that is received or internally generated by the control circuitry 1080.

Assuming all of the switches 1012-1026 are initially open, then during a first phase ϕ1 of operation of the first balancer circuitry 1000 (which is synchronised to a first cycle of the clock signal), the first, third, fifth and seventh switches 1012, 1016, 1020, 1024 are closed (as shown in FIG. 10b), in response to control signals from the control circuitry 1080, and the other switches of the switch network 1010 remain open.

Thus, during the first phase ϕ1, the first and second capacitors 1062, 1064 are coupled to the first cell 602, the second and third capacitors 1064, 1066 are coupled to the second cell 604, and the third and fourth capacitors 1066, 1068 are coupled to the third cell 606.

Current can therefore flow between the first cell 602 and the capacitors 1062, 1064 during the first phase. The direction of current flow will depend upon the voltage across the first cell 602 and across each of the capacitors 1062, 1064. For example, if at the start of the first phase the first cell 602 is at a relatively high voltage or state of charge and the first and second capacitors 1062, 1064 are at a relatively voltage or low state of charge, then during the first phase current will flow from the first cell 602 to the capacitors 1062, 1064, thereby charging the capacitors 1062, 1064.

Current will also flow between the second cell 604 and the second and third capacitors 1064, 1066 in the first phase, in a direction that is dependent upon the voltage across the second cell 604 and across the second and third capacitors 1064, 1066, to charge either the second cell 604 or the second and third capacitors 1064, 1066.

Similarly, current will flow between the third cell 606 and the third and fourth capacitors 1066, 1068 in the first phase, in a direction that is dependent upon the voltage across the third cell 606 and across the third and fourth capacitors 1066, 1068, to charge either the third cell 606 or the third and fourth capacitors 1066, 1068.

During a second phase ϕ2 of operation of the first balancer circuitry 1000 (which is synchronised to a second cycle of the clock signal), the second, fourth, sixth and eighth switches 1014, 1018, 1022, 1026 are closed (as shown in FIG. 10c), in response to control signals from the control circuitry 1080, and the other switches of the switch network 1010 are opened. Thus, during the second phase ϕ2, the first and second capacitors 1062, 1064 are coupled to the second cell 604, the second and third capacitors 1064, 1066 are coupled to the third cell 606, and the third and fourth capacitors 1066, 1068 are coupled to the fourth cell 608.

Current can therefore flow between the second cell 604 and the first and second capacitors 1062, 1064. Again, the direction of current flow will depend upon the voltage across the second cell 604 and across the first and second capacitors 1062, 1064. For example, if at the start of the second phase the first and second capacitors 1062, 1064 are at a relatively high voltage or state of charge and the second cell 604 is at a relatively low voltage or state of charge, then during the second phase, current will flow from the first and second capacitors 1062, 1064 to the second cell 604, thereby charging the second cell.

Current will also flow between the third cell 606 and the second and third capacitors 1064, 1066 in the second phase, in a direction that is dependent upon the voltage across the third cell 606 and across the second and third capacitors 1064, 1066, to charge either the third cell 606 or the second and third capacitors 1064, 1066.

Similarly, current will flow between the fourth cell 608 and the third and fourth capacitors 1066, 1068 in the second phase, in a direction that is dependent upon the voltage across the fourth cell 608 and across the third and fourth capacitors 1066, 1068, to charge either the fourth cell 608 or the third and fourth capacitors 1066, 1068.

As will be appreciated, in the first balancer circuitry 1000 shown in FIGS. 10a-10c charge is transferred between individual cells of the set of cells 602-608 and the capacitors 1062-1068 in consecutive phases ϕ1, ϕ2.

In the illustrated example the set of cells comprises four cells 602-608, the set of capacitors 1060 comprises four capacitors 1062-1068, and the switch network 1010 comprises eight switches 1012-1026. More generally, for first balancer circuitry of the kind illustrated in FIG. 10a, the set of capacitors 1060 comprises N capacitors, each associated with two switches such that the switch network comprises 2N switches, where N is the number of cells in the set of series-connected cells.

Referring again to FIG. 6, the cell balancing system of the present disclosure comprises a combination of first balancer circuitry 610 and second balancer circuitry 620.

The first balancer circuitry 610 may be balancer circuitry of the kind described above with reference to FIGS. 5 and 10a-10c, or may be any other balancer circuitry in which an individual cell of a set of cells transfers energy to, or receives energy from, an energy storage element in an operational cycle of the first balancer circuitry 610.

The second balancer circuitry 620 may be balancer circuitry of the kind described above with reference to FIG. 7a-7d, 8a-8c or 9a-9c, or may be any other balancer circuitry in which a subset comprising a plurality of series-connected cells of a set of cells transfers energy to, or receives energy from, an energy storage element in an operational cycle of the second balancer circuitry 620.

This combination of first balancer circuitry 610, configured to perform cell balancing of a set of cells on a cell-by-cell basis, and second balancer circuitry 620, configured to perform cell balancing on the set of cells on a subset-by-subset basis, gives rise to a reduction in the time taken to balance the set of cells, in comparison to a system which uses only first balancer circuitry for cell balancing on a cell-by-cell basis.

Simulation results suggest that the combination of first balancer circuitry 610 and second balancer circuitry 620 in accordance with the present disclosure may reduce the time required to balance the set of cells (to an arbitrarily chosen degree of mismatch between cell voltages) to between about 58% and about 76% of the time required to balance the set of cells using only first balancer circuitry.

Any combination of implementations of first balancer circuitry and second balancer circuitry may be used, and the choice of which implementation of the first and second balancer circuitry to deploy will depend upon the desired balancing speed and considerations relating to component cost and space, circuit complexity, power consumption and the like.

For example, the combination of first balancer circuitry 1000 of the kind shown in FIGS. 10a-10c and second balancer circuitry 700 of the kind shown in FIGS. 7a-7d may give rise to a balancing time that is approximately 58% of the balancing time, for a set of four cells, of the first balancer circuitry 1000 alone. For a set of four cells, such a combination would require a total of 26 switches (eight in the first balancer circuitry 1000 and 18 in the second balancer circuitry 700) and seven capacitors (four in the first balancer circuitry 1000 and three in the second balancer circuitry 700), i.e. an increase of 18 switches and three capacitors over the use of the first balancer circuitry 1000 alone.

The combination of first balancer circuitry 1000 of the kind shown in FIGS. 10a-10c and second balancer circuitry 800 of the kind shown in FIGS. 8a-8c may give rise to a balancing time that is approximately 63% of the balancing time, for a set of four cells, of the first balancer circuitry 1000 alone. For a set of four cells, such a combination would require a total of 14 switches (eight in the first balancer circuitry 1000 and six in the second balancer circuitry 800) and seven capacitors (four in the first balancer circuitry 1000 and three in the second balancer circuitry 800), i.e. an increase of six switches and three capacitors over the use of the first balancer circuitry 1000 alone.

The combination of first balancer circuitry 1000 of the kind shown in FIGS. 10a-10c and second balancer circuitry 900 of the kind shown in FIGS. 9a-9c may give rise to a balancing time that is approximately 76% of the balancing time, for a set of four cells, of the first balancer circuitry 1000 alone. For a set of four cells, such a combination would require a total of twelve switches (eight in the first balancer circuitry 1000 and four in the second balancer circuitry 900) and six capacitors (four in the first balancer circuitry 1000 and two in the second balancer circuitry 900), i.e. an increase of four switches and two capacitors over the use of the first balancer circuitry 1000 alone.

Thus the combination of first balancer circuitry 1000 of the kind shown in FIGS. 10a-10c and second balancer circuitry 700 of the kind shown in FIGS. 7a-7d provides the fastest balancing speed of the combinations discussed above, but also has the highest component count, and may also have the highest cost, power consumption, circuit complexity and circuit area. Conversely, the combination of first balancer circuitry 1000 of the kind shown in FIGS. 10a-10c and second balancer circuitry 900 of the kind shown in FIGS. 9a-9c provides the slowest balancing speed of the combinations discussed above (which is still faster than using first balancer circuitry alone), but requires the fewest components and may also have the lowest cost, power consumption, circuit complexity and circuit area.

In use of the cell balancing system 600, the first and second balancer circuitry 610, 620 may receive a single common clock signal from a common clock, such that the first and second balancer circuitry 610, 620 operate at the same speed or frequency. Alternatively, the first balancer circuitry 610 may receive a first clock signal from a first clock and the second balancer circuitry 620 may receive a second clock signal from a second clock that is separate from and independent of the first clock. The use of independent clock signals in this way allows the first and second balancer circuitry 610 to operate at different speeds or frequencies.

In use of the cell balancing system 600, the first and second balancer circuitry 610, 620 may operate simultaneously. However, in some applications it may be desirable, to reduce the power consumption of the cell balancing system, for the first balancer circuitry 610 to operate continuously, and for the second balancer circuitry 620 to be disabled or operative at a very low frequency unless a predetermined condition is met. For example, in normal operation of the cell balancing system the first cell balancer circuitry 610 may operate continuously, and the second cell balancer circuitry 620 may be disabled or operative at a low frequency (as defined by the clock signal it receives). If the degree of mismatch between the voltage or state of charge of the cells reaches a first predetermined threshold level (indicating that faster or additional balancing of the cells is required), the second cell balancer circuitry 620 may be enabled or may receive a higher frequency clock signal, to effect the required faster or additional cell balancing. Once the degree of mismatch between the voltage and/or state of charge of the cells falls below a second predetermined threshold level (which may be the same as or different from the first predetermined threshold level), the second cell balancer circuitry 620 may be disabled or may receive a lower frequency clock signal.

In embodiments in which both the first and second balancer circuitry 610, 620 are implemented using parallel capacitor arrangements (e.g. where the first balancer circuitry 610 is implemented using circuitry 1000 of the kind illustrated in FIG. 10a and the second balancer circuitry is implemented using circuitry 800, 900 of the kind illustrated in FIG. 8a or FIG. 9a), the common node 1070 of the first balancer circuitry 1000 and the common node 868/968 of the second balancer circuitry 800/900 may be coupled to each other and to voltage monitor circuitry to permit combined monitoring of voltages at these common nodes 1070. Alternatively, the common nodes 1070, 868/968 may each be coupled to separate voltage monitor circuitry, to permit the voltage at each common node 1070, 868/968 to be monitored separately. The voltage monitor circuitry (whether common to, or separate for, the first and second balancer circuitry 610, 620) may be configured to monitor the voltage at the common node 868/968 of the second balancer circuitry 620 and to selectively enable or disable a subset of the set of capacitors 860/960 based on the voltage at the common node 868/968.

The settling behaviour of the first balancer circuitry 610 and the second balancer circuitry 620 can be described using time constant r. For the first balancer circuitry 610 (which may be referred to as a single-cell balancer, because it performs cell balancing on a cell-by-cell basis, i.e. each capacitor or set of capacitors acting on a single cell per phase), this time constant r is set by the product of the effective capacitance of the cell being balanced and the resistance of the switch(es) that are coupled to the cell. For the second balancer circuitry 620 (which may be referred to as a multi-cell balancer, because it performs balancing on a subset-by-subset basis, i.e. each capacitor or set of capacitors acting on two or more cells per phase), this time constant r is reduced, e.g. for second balancing circuitry 620 that acts on a set of two cell per phase, the time constant r is effectively halved when compared to balancer circuitry that acts on a single cell per phase. Adding additional multi-cell balancers e.g. three- or four-cell balancers, continues to reduce τ. However, beyond the two-cell balancer, returns are diminished. For example, the time constant r may not decrease linearly as the number of cells that are acted on per phase increases.

It will be understood that the balancer configurations may comprise two components—first (single-cell) balancer circuitry 610 and second (multi-cell) balancer circuitry 620. Whilst in most situations the first and second balancer circuitry 610, 620 will operate concurrently, in some scenarios it may be desirable to run the second (multi-cell) balancer circuitry 620 for a first period until a predefined condition is met, e.g. until the voltages (e.g. the cell voltages) settle, and then run the first (single-cell) balancer circuitry 610 thereafter. This may result in a slower but potentially more energy-efficient redistribution of charge.

The cell balancing system of the present disclosure may be implemented as a combination of one or more integrated circuits (chips) comprising the switches that make up the first and/or second switch networks the cell balancing systems, and external (i.e. off-chip) capacitors of the first and/or second sets of capacitors. The integrated circuit(s) may also comprise control circuitry for controlling the first and second switch networks of the cell balancing system. Alternatively, the control circuitry may be provided as one or more separate integrated circuits.

The present disclosure extends to a module comprising one or more first integrated circuits comprising the switches that make up the first and/or second switch networks of the instances of the cell balancing system and capacitors of the first and/or second sets of capacitors. The module may include one or more second integrated circuits comprising the control circuitry, or alternatively the control circuitry may be provided in the first integrated circuit(s).

As will be apparent to those of ordinary skill in the art, the present disclosure provides circuitry and methods for actively balancing cells of a set of cells, e.g. battery pack (or a battery or battery module) that can reduce the time required to balance the cells, and reduce the risk of significant imbalances between cells. Because the active cell balancing circuitry and techniques described herein do not waste energy as heat, but instead redistribute it to cells with a relatively lower voltage and/or state of charge, the battery pack needs to be charged less frequently from an external energy source, leading to a reducing in the total amount of energy it consumes for charging over its useable lifetime, and hence to a reduction in the environmental impact of the battery pack, in comparison to a battery pack that is not subject to active cell balancing.

In the foregoing description and the accompanying drawings, the battery packs and modules are shown as comprising sets of individual cells connected in series. It is to be understood, however, that the term “cell” as used in the present disclosure may refer to a single cell or to submodule comprising a series or parallel combination of two or more cells that is used as a single cell in a battery pack or module.

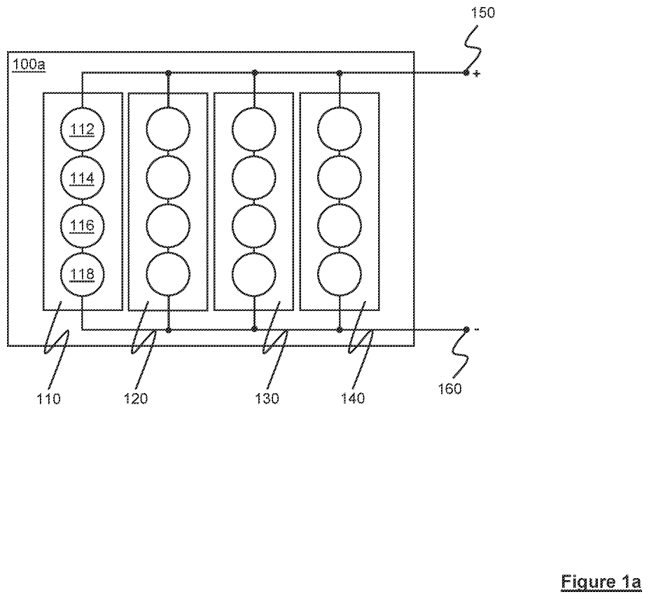

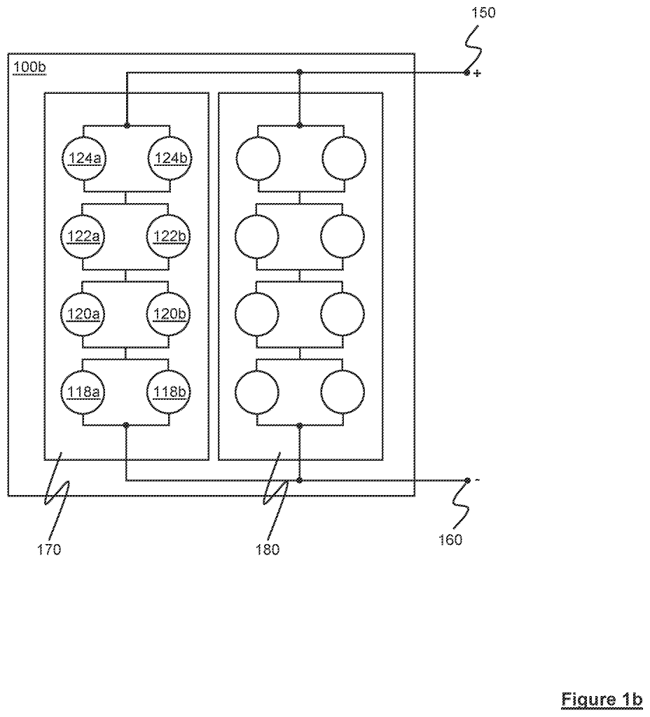

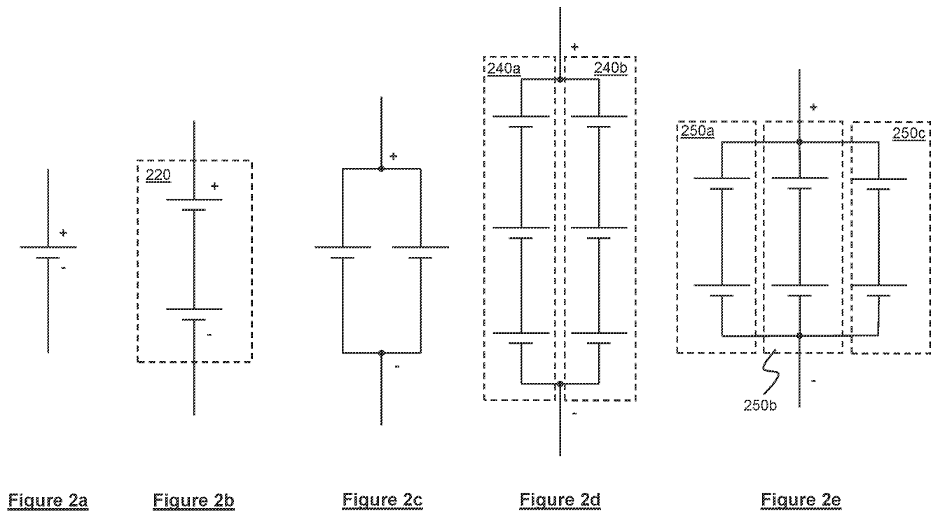

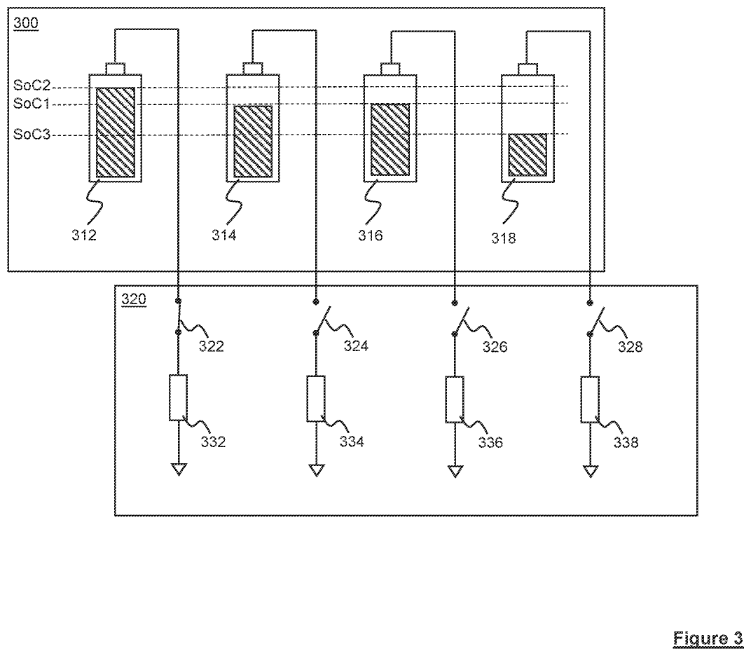

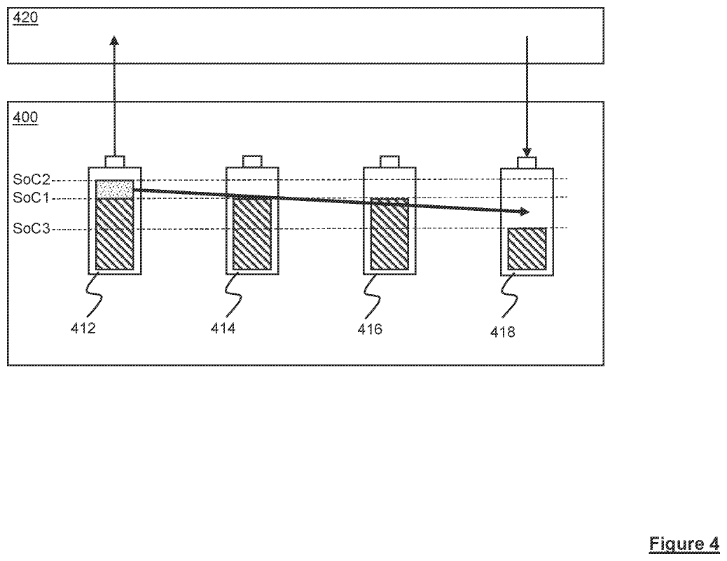

As will be appreciated by those of ordinary skill in the art, cell balancing strategies may be most effective for battery packs configured in the manner shown in FIG. 1a, because balancing circuitry can be coupled to each individual cell (except those cells of a module that are coupled to cells of another module, e.g. cells 112 and 118 in FIG. 1a), thus permitting balancing on an almost per-cell basis. In contrast, for battery packs configured in the manner shown in FIG. 1b, balancing can be performed for each pair of parallel-connected cells (e.g. 118a, 118b), and a degree of passive cell balancing will naturally occur between the cells of each pair.

In the forgoing discussion the present disclosure is presented in the context of reducing the charging time of batteries used in electric vehicles. As will be apparent to those of ordinary skill in the art, the principles of the present disclosure are equally applicable to rechargeable battery packs, battery modules and batteries used in other devices, apparatus or applications, e.g. cordless power tools, computing devices such as laptop, tablet and netbook computers, portable devices such as mobile telephones and the like. Thus the present disclosure is not limited to battery packs and associated charging systems and methods for electric vehicles, but extends to battery packs, battery modules, batteries and associated charging systems and methods for other applications, devices or apparatus.

The cell balancing system described above with reference to the accompanying drawings may be incorporated in a host device such as a laptop, notebook, netbook or tablet computer, a gaming device such as a games console or a controller for a games console, a virtual reality (VR) or augmented reality (AR) device, a mobile telephone, a portable audio player or some other portable device, or may be incorporated in an accessory device for use with a laptop, notebook, netbook or tablet computer, a gaming device, a VR or AR device, a mobile telephone, a portable audio player or other portable device.

Alternatively, the cell balancing system described above with reference to the accompanying drawings may be incorporated in a battery, battery module or battery pack comprising a plurality of cells.

The skilled person will recognise that some aspects of the above-described apparatus and methods may be embodied as processor control code, for example on a non-volatile carrier medium such as a disk, CD- or DVD-ROM, programmed memory such as read only memory (Firmware), or on a data carrier such as an optical or electrical signal carrier. For many applications, embodiments will be implemented on a DSP (Digital Signal Processor), ASIC (Application Specific Integrated Circuit) or FPGA (Field Programmable Gate Array). Thus the code may comprise conventional program code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

1. A cell balancing system for balancing a set of series-connected cells, the cell balancing system comprising:
first balancer circuitry comprising a first set of capacitors and a first switch network, wherein the first switch network is controllable such that in operation of the cell balancing system:
during a first phase of operation of the first balancer circuitry, a capacitor of the first set of capacitors is coupled to a first cell of the set of series-connected cells; and
during a second phase of operation of the first balancer circuitry, the capacitor of the first set of capacitors is coupled to a second cell of the set of series-connected cells; and
second balancer circuitry comprising a second set of capacitors and a second switch network, wherein the second switch network is controllable such that in operation of the cell balancing system:
during a first phase of operation of the second balancer circuitry, a capacitor of the second set of capacitors is coupled to a first subset of cells of the set of series-connected cells, the first subset comprising two or more of the set of series-connected cells; and
during a second phase of operation of the second balancer circuitry, the capacitor of the second set of capacitors is coupled to a second subset of cells of the set of series-connected cells, different than the first subset, the second subset comprising two or more of the set of series-connected cells.

2. A cell balancing system according to claim 1, wherein the second switch network is operable to couple the capacitor of the second set of capacitors in parallel with the first subset of cells during the first phase of operation of the second balancer circuitry, and to couple the capacitor in parallel with the second subset of cells during the second phase of operation of the second balancer circuitry.

3. A cell balancing system according to claim 2, wherein the second set of capacitors comprises N−1 capacitors, where N is the number of cells in the set of series connected cells.

4. A cell balancing system according to claim 2, wherein the second switch network comprises 2(N−1)² switches, where N is the number of cells in the set of series connected cells.

5. A cell balancing system according to claim 4, wherein each capacitor of the second set of capacitors is associated with 2(N−1) switches of the second switch network.

6. A cell balancing system according to claim 5, wherein an operational cycle of the second balancer circuitry comprises N−1 phases, and wherein over the course of an operational cycle of the second balancer circuitry, each capacitor of the second set of capacitors is coupled once to each of N−1 subsets of the set of series-connected cells, each subset comprising two or more cells.

7. A cell balancing system according to claim 1, wherein the second set of capacitors comprises a plurality of capacitors coupled in parallel between the second switch network and a common node.

8. A cell balancing system according to claim 7, wherein the second set of capacitors comprises N−1 capacitors, where N is the number of cells in the set of series connected cells.

9. A cell balancing system according to claim 8, wherein the second switch network comprises 2(N−1) switches.

10. A cell balancing system according to claim 7, wherein the second set of capacitors comprises N/2 capacitors, where N is the number of cells in the set of series-connected cells, and where N is an integer multiple of 2.

11. A cell balancing system according to claim 10, wherein the second switch network comprises 2(N/2) switches.

12. A cell balancing system according to claim 1, wherein the first switch network is operable to couple the capacitor of the first set of capacitors in parallel with the first cell during the first phase of operation of the first balancer circuitry, and to couple the capacitor in parallel with the second cell during the second phase of operation of the second balancer circuitry.

13. A cell balancing system according to claim 12, wherein the first set of capacitors comprises N−1 capacitors, where N is the number of cells in the set of series-connected cells.

14. A cell balancing system according to claim 1, wherein the first set of capacitors comprises a plurality of capacitors coupled in parallel between the first switch network and a common node.

15. A cell balancing system according to claim 14, wherein the first set of capacitors comprises N capacitors, where N is the number of cells of the set of series-connected cells.

16. A cell balancing system according to claim 14, wherein the first switch network comprises 2N switches, where N is the number of cells of the set of series-connected cells.

17. A cell balancing system according to claim 14, wherein each capacitor of the first set of capacitors is associated with two switches of the first switch network.

18. A cell balancing system according to claim 1, further comprising control circuitry configured to control operation of the first switch network and the second switch network.

19. A cell balancing system according to claim 1, wherein the first balancer circuitry and the second balancer circuitry are configured to receive a common clock signal, or wherein the first balancer circuitry is configured to receive a first clock signal and the second balancer circuitry is configured to receive a second clock signal.

20. (canceled)

21. A cell balancing system according to claim 1, wherein the first set of capacitors comprises a first plurality of capacitors coupled in parallel between the first switch network and a first common node and the second set of capacitors comprises a second plurality of capacitors coupled in parallel between the second switch network and a second common node.

22.-24. (canceled)

25. A cell balancing system according to claim 1, wherein the first balancer circuitry and the second balancer circuitry are operable simultaneously or concurrently, or wherein the first balancer circuitry and the second balancer circuitry are operable separately of one another.

26. (canceled)

27. A cell balancing system according to claim 25, wherein the first balancer is operable continuously, and wherein the second balancer is inoperative or operative at a low frequency unless a predetermined condition is met.

28. A cell balancing system according to claim 27, wherein the predetermined condition comprises a threshold level of mismatch between a voltage or a state of charge between cells of the set of series-connected cells.

29. A cell balancing system according to claim 25, wherein the second balancer is operable for a first period until a predefined condition is met, and wherein the first balancer circuitry is operable thereafter.

30. An integrated circuit comprising a cell balancing system according to claim 1.

31. (canceled)

32. A host device comprising a cell balancing system according to claim 1, wherein the host device comprises an electric vehicle, an electric bicycle, a wheelchair, an electric scooter, a cordless power tool, a computing device, a laptop, notebook or tablet computer, a portable battery powered device, a mobile telephone or an accessory device for such a host device.

33. A battery pack comprising a cell balancing system according to claim 1.

34. An integrated circuit comprising a first switch network and/or a second switch network for a cell balancing system according to claim 1.

35. An integrated circuit according to claim 34, further comprising control circuitry for controlling the first and/or second switch networks.

36. (canceled)

37. A cell balancing system for balancing a set of series-connected cells, the cell balancing system comprising:
first balancer circuitry comprising a first set of capacitors and a first switch network, wherein the first set of capacitors comprises a plurality of capacitors coupled in parallel between the first switch network and a common node, and wherein the first switch network is controllable such that in operation of the cell balancing system:
during a first phase of operation of the first balancer circuitry, a capacitor of the first set of capacitors is coupled to a first cell of the set of series-connected cells; and
during a second phase of operation of the first balancer circuitry, the capacitor of the first set of capacitors is coupled to a second cell of the set of series-connected cells; and
second balancer circuitry comprising a second set of capacitors and a second switch network, wherein the second switch network is controllable such that in operation of the cell balancing system:
during a first phase of operation of the second balancer circuitry, a capacitor of the second set of capacitors is coupled to a first subset of cells of the set of series-connected cells, the first subset comprising two or more of the set of series-connected cells; and
during a second phase of operation of the second balancer circuitry, the capacitor of the second set of capacitors is coupled to a second subset of cells of the set of series-connected cells, different than the first subset, the second subset comprising two or more of the set of series-connected cells.

38. A cell balancing system for balancing a set of series-connected cells, the cell balancing system comprising:
first balancer circuitry comprising a first set of capacitors and a first switch network, wherein the first switch network is controllable such that in operation of the cell balancing system:
during a first phase of operation of the first balancer circuitry, a capacitor of the first set of capacitors is coupled to a first cell of the set of series-connected cells; and
during a second phase of operation of the first balancer circuitry, the capacitor of the first set of capacitors is coupled to a second cell of the set of series-connected cells; and
second balancer circuitry comprising a second set of capacitors and a second switch network, wherein the second set of capacitors comprises N−1 capacitors, where N is the number of cells in the set of series connected cells, and wherein the second switch network is controllable such that in operation of the cell balancing system:
during a first phase of operation of the second balancer circuitry, a capacitor of the second set of capacitors is coupled to a first subset of cells of the set of series-connected cells, the first subset comprising two or more of the set of series-connected cells; and
during a second phase of operation of the second balancer circuitry, the capacitor of the second set of capacitors is coupled to a second subset of cells of the set of series-connected cells, different than the first subset, the second subset comprising two or more of the set of series-connected cells.
